(19) United States
(12) Patent Application Publication
(10) Pub. No.: US 2026/0289070 A1
(43) Pub. Date: Sep. 24, 2026

(54) SYSTEM

(71) Applicant: SoftBank Group Corp., Tokyo (JP)

(72) Inventor: Hironobu KIKUCHI, Tokyo (JP)

(73) Assignee: SoftBank Group Corp., Tokyo (JP)

(21) Appl. No.: 19/564,193

(22) Filed: Mar. 12, 2026

(30) Foreign Application Priority Data
Mar. 19, 2025 (JP) 2025-044544

(51) Int. Cl. G06F 40/151; G06F 16/334; G06F 40/186; G06N 3/092; G06T 11/00; H04L 67/50

(52) U.S. Cl. CPC G06F 40/151; G06F 16/334; G06F 40/186; G06N 3/092; G06T 11/00; H04L 67/535

(57) ABSTRACT

A system includes a processor that is configured to collect data including a user's browsing history, profile information, preferences, and emotional state, analyze the collected data to identify an interest of the user and the emotional state of the user, and generate a prompt sentence for instructing a generative AI model to generate specific information.

### CROSS-REFERENCE TO RELATED APPLICATION

This application is based on and claims priority under 35 USC 119 from Japanese Patent Application No. 2025-044544 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information delivery systems generally provide the same or only coarsely segmented information to a wide range of users without sufficiently considering individual differences in a user's browsing history, profile information, preferences, and emotional state. As a result, the information presented to the user often lacks relevance, personalization, and emotional alignment, which leads to low user engagement and reduced effectiveness of the delivered content. In addition, even when some personalization is attempted, the process of converting user data into an appropriate input format, such as a prompt for a generative AI model, is often manual or heuristic, resulting in unstable quality and scalability issues. Therefore, there is a need for a system that can automatically collect and analyze user-related data, accurately identify the user's interests and emotional state, and systematically generate prompts for a generative AI model so that customized information appropriate to individual users can be generated and provided in a consistent and efficient manner.

### SUMMARY

In order to solve the above problem, an aspect of the present invention provides a system comprising a processor, wherein the processor is configured to collect data including a user's browsing history, profile information, preferences, and emotional state, analyze the collected data to identify an interest of the user and the emotional state of the user, and generate a prompt sentence for instructing a generative AI model to generate specific information. In one implementation, the processor is further configured to input the generated prompt sentence into the generative AI model and generate customized information according to an attribute of the user, thereby enabling the generative AI model to output information whose content and expression are adapted to the identified interests and emotional state of the user. In another implementation, the processor is further configured to transmit the generated information to a terminal of the user and cause the information to be displayed on the terminal of the user, so that the user can directly consume highly personalized information without additional manual intervention. By integrating these functions in the processor, the system can automatically convert rich user data into structured prompts and personalized outputs, thereby improving the relevance, engagement, and effectiveness of information delivery.

The term “system” refers to an arrangement of one or more hardware and/or software components that operate together to perform the processing defined in the claims, including at least a processor and, in some embodiments, one or more storage devices and communication interfaces.

The term “processor” refers to any hardware device or combination of hardware devices capable of executing instructions, including but not limited to a central processing unit (CPU), a graphics processing unit (GPU), an application-specific integrated circuit (ASIC), a field-programmable gate array (FPGA), or a combination thereof.

The term “data” refers to information that is acquired, stored, processed, or transmitted by the system, including but not limited to numerical values, text, symbols, identifiers, and metadata associated with a user or content.

The term “browsing history” refers to data indicating records of content accessed or operations performed by the user through a terminal, including, for example, identifiers of accessed pages or items, access timestamps, categories of accessed content, interaction logs, and viewing durations.

The term “profile information” refers to user-related attributes that are explicitly registered or stored for the user, such as age, gender, region, occupation, declared interests, account settings, and other demographic or preference information.

The term “preferences” refers to tendencies or likings of the user regarding content, topics, categories, or presentation styles, which may be explicitly specified by the user in the profile information or implicitly inferred from the browsing history or other user behavior.

The term “emotional state” refers to a condition or tendency of the user's feelings at a given time or over a period of time, such as being happy, sad, excited, frustrated, or calm, which can be estimated based on user data including browsing behavior, interaction patterns, and optionally physiological or feedback signals.

The term “analyze” refers to performing processing on collected data so as to extract, infer, classify, or otherwise determine information such as user interests, attributes, or emotional states, using rule-based methods, statistical methods, machine learning, or any combination thereof.

The term “interest of the user” refers to one or more topics, categories, subjects, or types of content toward which the user exhibits a relatively high degree of attention, engagement, or preference, as determined based on the analysis of the collected data.

The term “prompt sentence” refers to text or a structured string that is generated by the processor and supplied to a generative AI model as an instruction or input, the prompt sentence specifying at least a requested content type, topic, style, or other conditions for generating specific information.

The term “generative AI model” refers to a machine learning model that is trained using techniques such as deep learning to generate new content, including but not limited to text, based on an input such as a prompt sentence, and may be implemented, for example, as a large language model or another generative model.

The term “specific information” refers to information that is generated by the generative AI model in response to the prompt sentence, the information having a content, structure, or style determined at least in part by the instructions contained in the prompt sentence.

The term “attribute of the user” refers to any characteristic associated with the user, including but not limited to interests, preferences, demographic information, behavioral patterns, and emotional states, which are used to customize the generated information. The term “customized information” refers to information generated by the generative AI model that is adapted or tailored to one or more attributes of the user, such that the content or expression differs from information that would be generated without considering such attributes.

The term “terminal” refers to an electronic device used by the user to access or receive information from the system, such as a smartphone, tablet, personal computer, laptop, or any other communication-enabled display device. The term “transmit” refers to causing data or information to be sent from the system to a terminal via a wired or wireless communication network, using one or more communication protocols.

The term “display” refers to presenting information in a human-perceivable form on a screen or other output interface of the terminal, including but not limited to rendering text, images, or user interface elements that contain or represent the generated information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

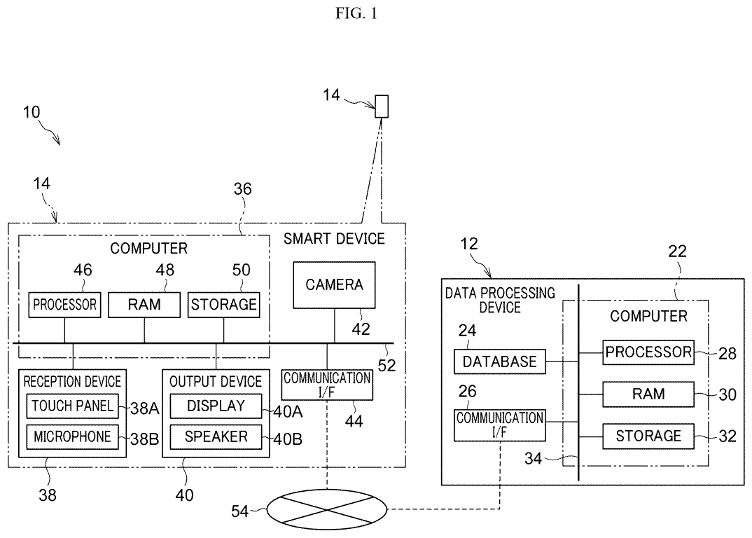

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

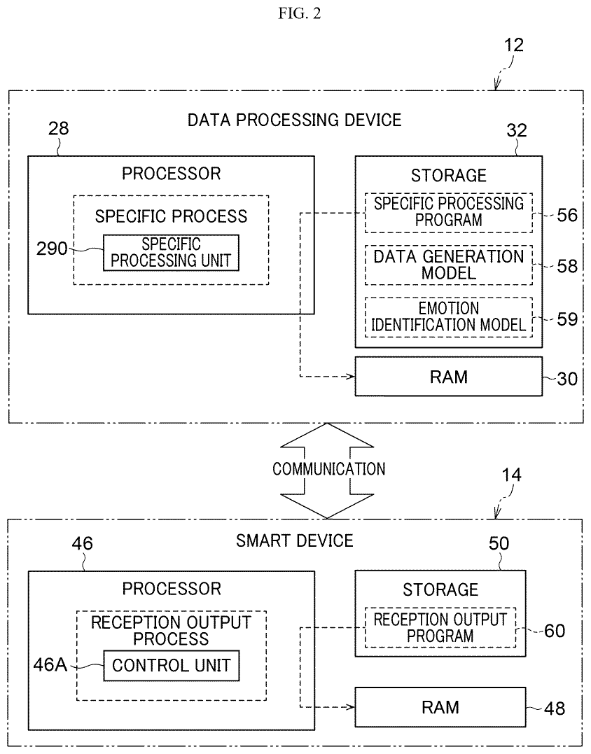

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information delivery systems that employ machine learning or content recommendation frequently treat personalization as a simple ranking or filtering problem. Such systems typically rely on coarse user attributes and aggregate viewing statistics to select items from a fixed content pool. As a result, they fail to generate new content that is precisely tailored to a user's fine-grained preferences regarding linguistic style, regional language usage, emphasis level, conciseness, and tense control. In addition, existing systems that invoke generative AI models commonly construct prompt sentences in an ad hoc manner, without systematic use of machine-learned user characteristic information, without iterative refinement based on user feedback, and without structured post-processing of generated text.

From a computer-technology perspective, these limitations manifest as inefficient and suboptimal utilization of computational resources and models. First, the absence of a machine-optimized pipeline from user behavior logs to prompt construction results in prompt sentences that do not effectively constrain the generative AI model, causing redundant generation, unnecessary token usage, and increased latency on computing hardware. Second, the lack of automated style and tense control forces downstream applications or human operators to perform manual editing, which does not scale and prevents end-to-end automation on server-side processing resources. Third, conventional systems do not exploit reinforcement-type updating of user models and prompt parameters based on explicit and implicit feedback, thereby failing to adapt the behavior of the generative AI model over time in a way that improves system-level performance metrics such as user engagement, server throughput, and response-time predictability.

Accordingly, there is a need for a computer-implemented technique that (i) automatically acquires and analyzes behavior-related information of a user by using machine learning and natural language processing, (ii) systematically generates prompt sentences that explicitly encode constraints derived from user characteristic information, (iii) controls a generative AI model through such prompt sentences, and (iv) performs structured post-processing of the generated natural language text, all under centralized control of a processor. Such a technique should improve the functioning of the server system itself by enabling more efficient use of generative AI computation, reducing unnecessary regeneration and manual editing, and producing outputs that better match user-specific preferences in a repeatable, machine-controlled manner.

The specific processing by the specific processing unit 290 of the data processing device 12 in Example 1 is realized by the following means.

The present invention provides a server comprising a processor and a memory storing instructions that, when executed by the processor, cause the processor to acquire and store behavior-related information including viewing history information, attribute information, preference information, and emotion information of a user; execute information analysis processing including machine learning processing and natural language processing on the behavior-related information to extract user characteristic information including a field of interest of the user, a preferred amount of information, a preferred writing style, a preferred use of region-specific language, a preferred degree of emphasis, and a preferred tense; generate, based on the user characteristic information, a prompt sentence in which constraint conditions including a target field of generated information, an amount of the generated information, a language style, region-specific expressions, soft expressions or emphasized expressions, conciseness, and a tense specification for past information are explicitly described; configure the generated prompt sentence as input data to be input to a generative AI model and acquire natural language text output from the generative AI model so as to be compatible with the user characteristic information; execute post-processing including at least one of writing-style conversion processing, region-specific expression adding processing, and tense adjustment processing on the natural language text acquired from the generative AI model to generate information content to be presented to the user; and transmit the generated information content to a terminal device of the user and control output so that the information content becomes displayable on the terminal device. This enables an improved computer-implemented personalization pipeline in which the server dynamically optimizes prompt sentences and post-processing operations under programmatic control, thereby more effectively constraining the generative AI model, reducing unnecessary computation and manual editing, and generating user-specific information content that more accurately reflects fine-grained user preferences while improving the overall efficiency and technical performance of the server system.

The term “behavior-related information” refers to information indicative of actions or states associated with a user, including but not limited to viewing history information, attribute information, preference information, and emotion information, which is acquired and stored by the system for analysis.

The term “viewing history information” refers to information representing records of content that a user has accessed, such as identifiers of content items, access times, categories, and interaction logs, which can be used to infer the user's interests and behavior patterns. The term “attribute information” refers to information indicating relatively static properties of a user, such as demographic attributes, region, language setting, or device type, which can influence how information is to be generated and presented.

The term “preference information” refers to information indicating likes, dislikes, or tendencies of a user with respect to content, style, or format, which may be derived from explicit feedback or implicit behavioral signals.

The term “emotion information” refers to information indicative of an emotional state of a user, which may be inferred from interaction patterns, textual input, or other signals, and which is used to characterize or adapt content generation.

The term “information analysis processing” refers to processing that analyzes behavior-related information by applying computational techniques including machine learning processing and natural language processing to derive higher-level representations such as user characteristic information.

The term “machine learning processing” refers to processing in which a computer applies a model trained on data, or updates such a model, to detect patterns, classify inputs, or predict attributes, including but not limited to models for user interest estimation or style preference prediction.

The term “natural language processing” refers to processing in which a computer analyzes, interprets, or generates human language text, including operations such as tokenization, parsing, feature extraction, classification, and text transformation.

The term “user characteristic information” refers to information that represents inferred characteristics of a user, including at least a field of interest of the user, a preferred amount of information, a preferred writing style, a preferred use of region-specific language, a preferred degree of emphasis, and a preferred tense.

The term “field of interest” refers to a subject area or topic category, such as technology, finance, or entertainment, that is inferred to be of particular interest to a user based on analysis of behavior-related information.

The term “preferred amount of information” refers to a desired quantity or level of detail of content for a user, such as concise summaries, medium-length explanations, or detailed articles, inferred from user behavior or feedback.

The term “preferred writing style” refers to one or more stylistic properties of text favored by a user, including formality level, sentence length, and narrative structure, which are used to guide content generation.

The term “preferred use of region-specific language” refers to a preference of a user with respect to usage of language variants, dialects, or localized expressions associated with a particular geographic or cultural region.

The term “preferred degree of emphasis” refers to a preference of a user regarding how strongly content should highlight or stress particular points, including use of strong adjectives, emphatic phrasing, or restrained and neutral wording.

The term “preferred tense” refers to a preference of a user with respect to grammatical tense usage, for example, the extent to which past events are consistently expressed in a past tense, or current topics are expressed in present tense.

The term “prompt sentence” refers to a natural language instruction text generated by the system that explicitly specifies constraint conditions for content generation and is used as input to a generative AI model.

The term “constraint conditions” refers to explicit parameters or requirements embedded in a prompt sentence, including at least a target field of generated information, an amount of generated information, a language style, region-specific expressions, soft expressions or emphasized expressions, conciseness, and a tense specification for past information.

The term “target field of generated information” refers to the primary subject area or topic about which the generative AI model is to generate content, such as a particular technology domain or application domain.

The term “amount of generated information” refers to a specified quantity or level of detail of text to be produced by the generative AI model, such as a number of words, paragraphs, or a qualitative indication such as “brief” or “detailed.”

The term “language style” refers to a set of linguistic attributes of generated text, including formality, tone, vocabulary level, and structural features, which may be tailored according to user characteristic information.

The term “region-specific expressions” refers to words, phrases, or constructions characteristic of a particular geographic or cultural region, such as dialectal terms or localized idioms.

The term “soft expressions” refers to linguistic forms that reduce directness or intensity, such as polite, mitigated, or hedged phrasing, used to present information in a gentle or non-confrontational manner.

The term “emphasized expressions” refers to linguistic forms that increase intensity or highlight importance, such as strong adjectives, repeated phrases, or emphatic constructions, used to stress particular content.

The term “conciseness” refers to a property of generated text in which extraneous or redundant information is minimized to achieve a compact and focused presentation.

The term “tense specification for past information” refers to an instruction or parameter that requires information about past events to be described using a particular grammatical tense, typically a past tense form.

The term “generative AI model” refers to a computational model that, given input such as a prompt sentence, produces natural language text by predicting sequences of words or tokens, the model being implemented, for example, as a parameterized neural network.

The term “natural language text” refers to a sequence of human-readable words or sentences in a natural language, such as English or another human language, generated or processed by the system.

The term “writing-style conversion processing” refers to processing that transforms an existing text from one writing style to another, for example, from formal to casual, or from long-form narrative to bullet-point summary.

The term “region-specific expression adding processing” refers to processing that modifies a text to introduce or replace certain terms or phrases with region-specific expressions corresponding to a target geographic or cultural region.

The term “tense adjustment processing” refers to processing that analyzes and modifies verbs or related expressions in a text to conform the text to a specified grammatical tense requirement.

The term “information content” refers to natural language text, optionally with associated metadata, generated and post-processed by the system for presentation to a user. The term “terminal device” refers to an information processing device operated by or accessible to a user, such as a mobile device, a personal computer, or another communication device, capable of receiving and displaying information content.

The term “evaluation information” refers to explicit feedback provided by a user regarding content or system behavior, such as ratings, likes, dislikes, or selection of preference options.

The term “operation history information” refers to information indicating user operations on a terminal device, such as clicks, scroll actions, dwell times, and selection actions, which can be used as implicit feedback.

The term “reinforcement learning processing” refers to a type of machine learning processing in which a system updates its policy or parameters based on reward signals derived from user evaluation information or operation history information, in order to improve future behavior.

The term “template information” refers to stored generic text patterns or structures for prompt sentences, associated with different fields of interest or output formats, which can be selected or combined to form a concrete prompt sentence.

The term “generation target field” refers to a specific subject or topic category associated with template information and used as a basis for generating content via the generative AI model.

The term “output format” refers to a structural or presentational specification for generated text, such as narrative paragraphs, bullet lists, headings, or other layout-oriented forms, which can be controlled through prompt sentences or post-processing.

In one embodiment, a server, a terminal, and a user cooperate to implement the invention. The server includes at least one processor, a main memory, a nonvolatile storage device, a network interface, and an operating system. The server is deployed, for example, as a virtual machine instance on a general-purpose cloud computing platform. The server uses a central processing unit such as a multi-core x86-compatible processor, and in some embodiments the server additionally uses a graphics processing unit for acceleration of machine learning inference. The server executes middleware such as a web server, an application server, and a database management system. For example, the server executes a web server implemented by generic HTTP server software, executes backend logic by an application framework such as a scripting-language framework, and manages persistent data using a relational database management system such as a generic SQL database engine.

The terminal is implemented as an information processing device such as a smartphone, tablet, or personal computer. The terminal includes a processor, a memory, a display, an input interface, and a communication interface. The terminal executes a web browser or a native application. The terminal communicates with the server over a packet-based network using a secure communication protocol. The user operates the terminal to view content, give feedback, and thereby provide behavior-related information.

The server stores in the database one or more tables for behavior-related information. For example, the server uses a table that stores viewing history information of each user. The viewing history information includes a user identifier, a content identifier, a content category, a timestamp, and interaction metrics such as scroll depth or dwell time. The server further uses a table that stores attribute information of each user, such as region, language preference, and device type. The server also uses a table for preference information, such as explicit “like” or “dislike” flags, and a table for emotion information, such as sentiment scores inferred from textual feedback. Each table is implemented as a structured data set with indexed columns to allow efficient query execution.

The server executes software modules to process the behavior-related information. In one embodiment, the server includes a feature-extraction module, a user-characteristic estimation module, a prompt-generation module, a generative-AI interaction module, and a post-processing module. Each module is implemented as a computer program stored in the memory and executed by the processor. The interaction between these modules is defined by a data flow in which intermediate results are stored either as in-memory data structures or as records in the database.

The server uses the feature-extraction module to transform raw behavior-related information into numerical and symbolic feature vectors. For example, the server tokenizes page titles and content snippets using a natural language processing library. The server converts tokens to integer identifiers by a vocabulary mapping and constructs sparse term-frequency or term-frequency-inverse-document-frequency vectors. The server also extracts categorical features such as content category, and numerical features such as counts of visits per category, average reading time, and frequency of interactions such as bookmarking. The server normalizes these numerical features by applying scaling functions so that each feature lies in a predetermined range. This explicit feature construction is different from manual human analysis because the server applies a consistent mathematical mapping across all users, enabling vectorized operations and efficient processing on modern CPU and GPU hardware.

The server uses the user-characteristic estimation module to infer user characteristic information from the feature vectors. In one example, the server loads a trained classification or regression model implemented by a neural network. The neural network has an input layer corresponding to the dimensions of the feature vector, multiple hidden layers that apply affine transformations and nonlinear activation functions such as rectified linear units, and an output layer that outputs, for example, probability distributions over interest fields, discrete labels of preferred writing style, continuous scores for preferred amount of information, and parameters indicating a preferred degree of emphasis and preferred tense. The server computes the output by applying matrix multiplications and activation functions on the feature vectors.

In one training method, the server has previously trained the neural network on a training data set of historical users. During training, the server uses a loss function that is a weighted sum of cross-entropy loss for categorical outputs such as field of interest labels, mean squared error loss for continuous outputs such as preferred length scores, and additional regularization terms to prevent overfitting. The server updates the weights of the neural network using a gradient-based optimization algorithm such as stochastic gradient descent or an adaptive variant. The server also applies data augmentation to textual inputs by synonym substitution and random masking to improve generalization. By training the model in this manner, the server obtains mappings from high-dimensional behavioral features to compact user characteristic vectors. These mappings are difficult for humans to reproduce manually and enable the server to produce consistent predictions at a much higher speed than human analysis.

The server uses reinforcement learning processing in some embodiments to adapt the user-characteristic estimation and prompt-generation behavior over time. The server treats each pair of prompt sentence and generated information content as an action and obtains a reward based on user evaluation information and operation history information. For example, the server calculates a scalar reward as a function of dwell time on the generated content, the presence of explicit positive feedback, and the absence of negative feedback. The server applies a policy-gradient or value-based reinforcement learning algorithm to adjust parameters that influence, for example, the weights given to different constraints in the prompt sentence. This processing causes the system to shift its operating point toward combinations of prompt structure and generative model parameters that produce higher user engagement per unit of computational resource, thereby improving the technical performance of the server.

The server uses the prompt-generation module to construct a prompt sentence for a generative AI model. The server holds template information for multiple generation target fields. Each template is represented as a text string with placeholder tokens corresponding to elements such as topic, length, tone, and tense instruction. The server selects one or more templates based on the field of interest and other user characteristic information and combines or fills the templates with specific constraint conditions. For example, the server generates a prompt sentence such as:

“Generate a concise, friendly article in American English about the latest AI technologies. Focus on recent developments in generative AI models, including large language models and image generators, that occurred in the past year. Use clear and soft expressions, but show passionate wording when describing breakthroughs that would excite a technology enthusiast. Write in the past tense when referring to previous releases or announcements.”

In another example, the server generates a prompt sentence such as:

“Generate a short, casual article in Japanese using a western-region dialect about the latest smartphone cameras. Emphasize excitement and enthusiasm, and keep each sentence relatively simple.”

In yet another example, the server generates a prompt sentence such as: “Create a detailed, formal English report on recent developments in quantum computing. Use the past tense to describe events from the last two years and avoid slang. Target a reader with an engineering background.”

The server performs this prompt generation by executing specific string-assembly operations that include selecting template fragments, inserting parameter values computed from the user characteristic vector, and enforcing ordering rules that place certain constraints at the beginning of the sentence to increase the probability that the generative AI model will respect these constraints. These deterministic operations yield prompt sentences that are tailored to both the user characteristics and the known behavior of the generative AI model.

The server uses the generative-AI interaction module to communicate with a generative AI model. In one embodiment, the generative AI model is a transformer-based neural network deployed either on a dedicated model server operated by a service provider or on a GPU-equipped server under the same administrative control as the main server. The generative AI model includes an embedding layer, multiple self-attention layers, and a feed-forward output layer. The model takes as input a sequence of tokens representing the prompt sentence, computes contextualized representations via multi-head self-attention, and generates output tokens one by one according to a probability distribution over the vocabulary. The generative AI model has been previously trained on large-scale text corpora using a language modeling objective that minimizes the negative log-likelihood of training sequences.

The server configures call parameters such as maximum output token count, temperature, and top-k or top-p sampling thresholds to control the balance between determinism and diversity. By adjusting these parameters as a function of the user characteristic information, the server can reduce the generation of unnecessarily long or off-topic text, thereby lowering computation on the model hardware and reducing network transmission size. For example, for a user with a strong preference for concise content, the server sets a smaller maximum token count and lower sampling diversity, which reduces average inference time on the generative AI model and lowers resource usage.

The server receives natural language text from the generative AI model as a sequence of characters or tokens. The server uses the post-processing module to adjust the text according to the fine-grained user preferences. The server executes writing-style conversion processing by applying a style-transfer model or a set of syntactic transformation rules. For example, the server converts long sentences into shorter sentences by identifying clause boundaries and inserting sentence delimiters. The server performs region-specific expression adding processing by mapping standard terms to region-specific alternatives via a dictionary or learned mapping, and by inserting local idioms where appropriate. The server executes tense adjustment processing by performing part-of-speech tagging and dependency parsing on the generated text and rewriting verbs that do not match the specified tense. These operations are algorithmically defined and executed as computational transformations on text representations, not as manual edits.

The server stores the final information content in the database or an in-memory cache and then uses the network interface to transmit the content to the terminal. The server embeds metadata such as content length, topic category, and generation timestamp, enabling the terminal to manage presentation and the server to perform future analysis. The terminal receives the information content, displays a title and body text on the display, and accepts interactions such as scrolling, bookmarking, or rating. The terminal forwards these interactions to the server. The user reads the content and optionally provides explicit feedback such as selecting a “more like this” or “less like this” option, which the server records as evaluation information.

The server thereby implements a closed-loop system in which user behavior and feedback are used to adjust both the user characteristic information and the prompt-generation policy. Because the server uses explicit feature representations, trained models, and reinforcement learning updates, the server performs processing sequences that are not mere automation of human editorial work. Instead, the server reorganizes data at machine scale and uses optimization methods to improve computational efficiency. For example, by inferring that a specific user typically stops reading after a certain length, the server reduces the requested length of generated content, decreasing average model inference time and network usage. By better matching the user's language style and region-specific preferences, the system reduces the need for users to search manually for suitable content, which shortens the number of server requests and can reduce overall server load.

In another embodiment, the server uses an alternative generative AI model such as a smaller transformer or a recurrent neural network when the user's request can be satisfied by shorter or less complex content. The server chooses between different models based on the field of interest and required depth of explanation. By routing simple requests to a smaller model, the server reduces GPU or CPU load and improves response time, implementing a technical optimization of resource allocation.

In yet another embodiment, the server maintains multiple sets of template information corresponding to different output formats such as bullet lists, step-by-step guides, or narrative explanations. The server selects between these templates based on operation history information, such as whether the user tends to expand bullet lists or prefers continuous paragraphs. The server thus uses internal rules that are derived from measurable user interactions, and this template-selection mechanism changes the length and structure of the prompt sentences. This choice of prompt structure directly affects token utilization patterns inside the generative AI model and leads to reduced perplexity for the constrained domain, which has the technical effect of more stable and predictable inference runtimes.

In a further embodiment, the server partitions behavior-related information into time windows and uses temporal features in the user-characteristic estimation. For example, the server distinguishes between short-term interests inferred from the last few days and long-term interests derived from historical patterns. The server encodes these temporal aspects into the feature vector and uses a neural network architecture with separate sub-networks for short-term and long-term features, which are then combined in a later layer. This architecture allows rapid adaptation to new trends without forgetting stable preferences, thus increasing accuracy of content targeting and reducing the number of iterations required to converge to a satisfying prompt configuration.

In another embodiment, the server incorporates a rule-based conflict-resolution module that operates in conjunction with the learned models. When the user-characteristic estimation module outputs conflicting indications, such as both “very concise” and “detailed,” the server applies predefined prioritization rules that favor certain constraints for specific content fields. These rules are encoded as deterministic logic in the application layer. By embedding these rules into the machine-controlled pipeline, the server prevents unstable prompt generation that could otherwise cause excessive re-generation of content and fluctuating load on the generative AI infrastructure.

The described embodiments demonstrate that the server performs a series of specific, structured computations on particular data structures using concrete hardware and software components. The system is configured to improve technical aspects of computer operation, including reduction of unnecessary model inference calls, optimization of token-generation length, and improved cache utilization for prompt templates. The server thereby achieves enhanced processing speed, improved prediction accuracy of user preferences, reduced communication overhead, and lower error rates in linguistic style and tense usage, as compared with prior systems that do not employ the described combination of feature extraction, user characteristic modeling, template-based prompt sentence generation, and reinforcement-based adaptation tailored to a generative AI model.

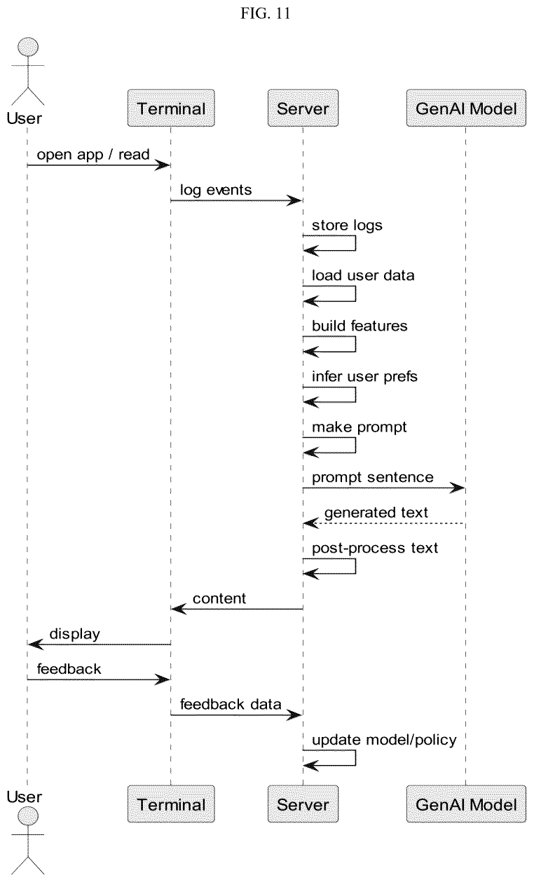

The following describes the processing flow using FIG. 11.

Step 1:

The user operates the terminal to access an application or website and to view content.

The terminal sends, as input to the server, request data including a user identifier, an authentication token, and context information such as the requested content category or page. The terminal also sends interaction events such as page views, scroll actions, and button selections.

The server receives these requests and events over a network interface and writes them into structured records in a database. The server performs data validation and normalization, such as checking the format of the user identifier and timestamps, and converts the raw HTTP requests into standardized event entries. The output of this step is a set of stored behavior-related records including viewing history information and operation history information for the user.

Step 2:

The server collects behavior-related information for the user from the database.

The input to this step is a user identifier and a time range defining the analysis window. The server executes database queries to retrieve viewing history information, attribute information, preference information, and emotion information associated with the user.

The server aggregates the retrieved records by content category, computes counts of views per category, calculates average reading times, and joins the behavior records with attribute records. The output of this step is a consolidated raw data set in memory that associates the user with multiple fields including content identifiers, categories, timestamps, interaction metrics, and static attributes.

Step 3:

The server generates feature vectors from the consolidated raw data set.

The input to this step is the consolidated raw data set produced in Step 2. The server applies data preprocessing operations, such as tokenizing content titles, mapping tokens to integers via a vocabulary, and generating term-frequency or term-frequency-inverse-document-frequency values. The server also encodes categorical data (for example, content category and device type) into numerical form and normalizes numerical features using scaling functions.

Through these data transformations, the server converts heterogeneous behavioral and attribute data into a fixed-dimensional numerical feature vector that is suitable as input to machine learning models. The output of this step is one or more feature vectors representing the behavior-related information of the user.

Step 4:

The server estimates user characteristic information using a trained machine learning model.

The input to this step is the feature vector generated in Step 3. The server loads a trained neural network model or another statistical model from storage into memory and performs an inference operation. The server feeds the feature vector into the model, performs matrix multiplications and activation functions across the model layers, and computes output values that represent predicted fields of interest, preferred amount of information, preferred writing style, preferred use of region-specific language, preferred degree of emphasis, and preferred tense.

The server interprets these outputs, for example by selecting the maximum-probability category or mapping continuous scores to discrete preference levels. The output of this step is a user characteristic information structure containing parameters that describe the user's preferences and interests.

Step 5:

The server updates user characteristic information and prompt-generation parameters using reinforcement learning.

The input to this step is the current user characteristic information from Step 4 and accumulated evaluation information and operation history information from previous content sessions. The server calculates a reward signal based on metrics such as dwell time on generated content, the presence of positive feedback, and the absence of negative feedback.

The server applies a reinforcement learning algorithm, such as a policy-gradient method, to update internal parameters that control, for example, weighting of constraints in the prompt sentence and selection probabilities of different template patterns. The server modifies policy parameters and possibly adjusts some of the user characteristic scores to better reflect observed behavior. The output of this step is an updated user characteristic information structure and updated policy parameters for prompt generation.

Step 6:

The server selects template information corresponding to a generation target field.

The input to this step is the user characteristic information, including the field of interest, preferred output format, and language style. The server searches a repository of template information, where each template is associated with a generation target field and an output format.

The server compares the field of interest and style preferences with template metadata and selects one or more templates with the highest matching score. If multiple templates are relevant, the server determines an ordering or combination strategy based on stored rules. The output of this step is one or more selected template strings and associated parameter slots that will be used to construct a prompt sentence.

Step 7:

The server generates a prompt sentence by filling the selected template information with user-specific constraints.

The input to this step is the selected template information from Step 6 and the detailed user characteristic parameters from Step 5 (for example, preferred amount of information, tone, region-specific expressions, and tense specification). The server performs string-assembly operations, inserting specific values into placeholder locations within the template. The server also enforces ordering constraints, such as placing topic and style requirements early in the prompt.

For example, the server generates a prompt sentence such as:

“Generate a concise, friendly article in American English about the latest AI technologies. Focus on recent developments in generative AI models, including large language models and image generators, that occurred in the past year. Use clear and soft expressions, but show passionate wording when describing breakthroughs that would excite a technology enthusiast. Write in the past tense when referring to previous releases or announcements.”

The output of this step is a fully formed prompt sentence that explicitly encodes constraint conditions for the generative AI model.

Step 8:

The server sends the prompt sentence to the generative AI model and configures generation parameters.

The input to this step is the generated prompt sentence from Step 7 and model-control parameters such as maximum output length and sampling temperature, which are derived from the user characteristic information. The server constructs a request payload, embedding the prompt sentence and generation parameters, and transmits this payload via a communication interface to a generative AI model endpoint.

The server thereby initiates a generation process on a remote or local generative AI model implementation. The output of this step is the pending request state and, after receiving a response, raw natural language text produced by the generative AI model.

Step 9:

The server receives natural language text from the generative AI model and performs writing-style conversion processing.

The input to this step is the raw natural language text received in response to the request in Step 8 and the user's preferred writing style parameters. The server applies a style-conversion module that may use a secondary model or rule-based transformations. The server splits long sentences, adjusts formality level, and restructures paragraphs into bullet lists or continuous text according to the user's preferences.

The server modifies the text by operating on the sequence of tokens or characters, producing a revised version of the generated text that better matches the preferred writing style. The output of this step is style-adjusted natural language text.

Step 10:

The server performs region-specific expression adding processing and tense adjustment processing on the style-adjusted text.

The input to this step is the style-adjusted text from Step 9 and user-specific parameters indicating region-specific language preferences and tense specification. The server first identifies standard expressions in the text and consults a dictionary or mapping table to substitute region-specific equivalents. The server then uses a part-of-speech tagging and dependency parsing component to locate verbs and related grammatical elements that do not comply with the specified tense.

The server rewrites these verbs into the correct tense form and updates surrounding words if necessary to maintain grammatical consistency. As a result, the server produces a final text that includes region-specific expressions and consistent use of the preferred tense. The output of this step is post-processed natural language text ready to be presented as information content.

Step 11:

The server packages the post-processed text into an information content object and stores metadata.

The input to this step is the post-processed text from Step 10 and context information such as the user identifier and generation timestamp. The server constructs a data structure that includes a title, a body, and metadata fields such as category, length, and generation time. The server may generate a title by extracting key phrases from the text or using a separate summarization function.

The server writes this information content object to a content table or a cache store for later retrieval, and generates a unique identifier for the content item. The output of this step is a stored or cached information content entry addressable by the server.

Step 12:

The server transmits the information content to the terminal for display.

The input to this step is the information content object from Step 11 and a delivery request or push condition that indicates when the user should receive the content. The server formats the object into a response message, for example including a title and body text fields, and sends the message via a secure communication protocol to the terminal associated with the user.

The terminal receives the message, parses the included fields, and renders the content on the display as a readable article or card. The output of this step is a visual presentation of the information content on the terminal and, indirectly, exposure of the generated content to the user.

Step 13:

The user interacts with the displayed content and provides explicit or implicit feedback.

The input to this step is the displayed content on the terminal. The user may scroll, close the content quickly, spend a long time reading, or activate controls such as “like,” “dislike,” “more like this,” or “less like this.” The terminal detects these interactions and encodes them as evaluation information and additional operation history information.

The terminal transmits this feedback data to the server, where it is appended to existing records in the database. The output of this step is updated feedback and behavior data that will be used as input in subsequent executions of Steps 2 through 5, thereby closing the adaptive loop of the system.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional personalization systems typically rely on static rules or shallow models that select items from a pre-existing content repository. Such systems often treat user attributes as coarse filters (for example, broad categories or demographic segments) and do not precisely control how content is linguistically realized for each individual user. As a result, even when generative AI models are introduced, they are frequently used in an ad hoc manner: a generic prompt is submitted, the resulting output is accepted largely as-is, and there is no systematic, fine-grained control over style, tone, dialect, complexity, or tense at the level of the underlying computer process.

From the standpoint of computer technology, these approaches have several technical drawbacks. First, user data such as viewing behavior, reaction events, and profile attributes are not transformed into a normalized, machine-usable representation that can be consistently reused across multiple generations. This leads to inefficient use of computing resources, because the generative AI model must implicitly infer user preferences each time from loosely specified prompts, causing variability in output quality and unnecessary computation. Second, the prompt sentences provided to the generative AI model are not structured to expose individual controllable dimensions (for example, primary and secondary interest domains, preferred tone type, regional language style, and comprehension difficulty) as explicit parameters. This limits the ability of the computing system to deterministically steer the generation process and to reproduce desired styles across sessions.

Third, conventional systems generally lack a closed feedback loop between the terminal-side interaction events and the server-side user attribute model. Viewing operations (such as scroll depth and dwell time) and reaction operations (such as save or share actions) are either not captured in sufficient detail or are not algorithmically integrated into the user model. Consequently, the server cannot algorithmically update the user attributes and prompt configuration in a systematic manner. This results in suboptimal adaptation over time, degraded personalization accuracy, and inefficient reuse of stored behavioral data.

Therefore, from the perspective of improving computer technology itself, there is a need for a system and associated processing method that: (i) transforms raw user-related data into normalized user attributes suitable for machine processing, (ii) constructs prompt sentences in which multiple content and style parameters are explicitly and separately encoded as descriptive elements for a generative AI model, and (iii) implements a feedback loop in which fine-grained viewing operation information and reaction information from the terminal are algorithmically used to update the user attributes. Such a system should enable stable, controllable, and computationally efficient generation of personalized information by a generative AI model, and should enhance the overall performance and reliability of the content generation pipeline executed by the processor.

The specific processing by the specific processing unit 290 of the data processing device 12 in Application Example 1 is realized by the following means.

The present invention provides a server comprising a processor configured to acquire, based on user identification information, usage history information and attribute information from a storage device; to extract and normalize user attributes including at least a field of interest, a preference for an expression style, a preference for a language style, and a preference for a level of comprehension difficulty; to construct, in a natural language, a prompt sentence that explicitly specifies, as separate descriptive elements, a primary field of interest, a secondary field of interest, a tone, a regional language style, a level of sentence complexity, a tense, and an emotional intensity of expressions, based on the normalized user attributes and generation conditions indicating an information field, an amount of information, and a time range; to input the prompt sentence and the user attributes into a generative AI model that uses at least deep learning and natural language processing, and to cause the generative AI model to generate personalized information in which content and expression style are adjusted according to the user attributes; to perform post-processing on the generated personalized information with respect to at least the expression style, safety, and length, and to format the generated personalized information into a display format; to transmit the formatted personalized information to an information terminal via a communication path; and to collect, from the information terminal, viewing operation information and reaction information including at least a movement amount of a display area, a dwell time, a selection operation, a save operation, and a share operation, and to update the user attributes by recalculating weighting of at least the field of interest, the preference for the expression style, and the preference for the level of comprehension difficulty based on the collected information so as to dynamically change, for subsequent generation, the prompt sentence and the personalized information. This enables the computing system to algorithmically convert heterogeneous user data into a stable, machine-optimized attribute representation; to exert fine-grained, reproducible control over multiple style and content dimensions of the generative AI model through structured prompt sentences; and to implement a closed feedback loop that continuously refines the user attributes based on detailed interaction signals, thereby improving the technical performance, efficiency, and reliability of personalized information generation.

The term “processor” refers to one or more hardware logic units, such as a central processing unit, a graphics processing unit, or a dedicated computation circuit, that execute machine-readable instructions to perform data acquisition, analysis, generation, and communication processes described in the present disclosure.

The term “user identification information” refers to data that uniquely or quasi-uniquely identifies a user or a user account within the system, such as a user ID, a session ID, or an anonymized identifier.

The term “usage history information” refers to data representing past interactions of the user with information resources, including at least viewed content items, categories, timestamps, dwell times, scroll behavior, and operation logs.

The term “attribute information” refers to data representing user-related characteristics other than usage history, including at least profile information such as demographic attributes, language preferences, interest tags, and declared preferences for content style or difficulty.

The term “storage device” refers to any physical or logical data storage apparatus, including volatile and non-volatile memory units, magnetic or optical storage, and remote or distributed storage, that stores usage history information, attribute information, and other data utilized by the processor.

The term “user attributes” refers to a set of structured parameters derived from usage history information and attribute information, including at least one field of interest, a preference for an expression style, a preference for a language style, and a preference for a level of comprehension difficulty, which are usable by the processor for content generation control.

The term “field of interest” refers to a category or domain of information, such as technology, finance, or sports, that indicates a thematic preference of the user inferred from usage history and attribute information.

The term “preference for an expression style” refers to a user-specific tendency regarding how information is linguistically expressed, including at least tone, directness or softness of expression, and degree of emotionality.

The term “preference for a language style” refers to a user-specific tendency regarding linguistic variants, such as a standard language form or a regional language form, and may include dialects or region-specific vocabulary.

The term “preference for a level of comprehension difficulty” refers to a user-specific tendency regarding the complexity of language and concepts used in generated information, such as a preference for plain, easy-to-understand sentences or for more technical, detailed descriptions.

The term “normalize” refers to a process of transforming heterogeneous raw data into a unified, machine-usable representation, including at least cleaning, standardizing formats, aggregating values, and mapping to defined attribute structures.

The term “generation conditions” refers to parameters defining requirements for information to be generated, including at least an information field, an amount of information, and a time range relevant to the content.

The term “prompt sentence” refers to a natural-language instruction string constructed by the processor, which explicitly encodes user attributes and generation conditions as descriptive elements and is provided as input to a generative AI model to control information generation.

The term “primary field of interest” refers to a field of interest determined, based on usage history information and attribute information, to be the most relevant or dominant domain for the user.

The term “secondary field of interest” refers to a field of interest that is relevant to the user but is ranked lower than the primary field of interest in terms of inferred importance or frequency.

The term “tone” refers to a style characteristic of linguistic expression, including at least friendliness, formality, strength or softness of wording, and emotional nuance of the generated text.

The term “regional language style” refers to a linguistic style associated with a geographic region, including dialectal expressions, region-specific vocabulary, and syntactic variations characteristic of that region.

The term “level of sentence complexity” refers to a degree of syntactic and lexical complexity in generated sentences, including sentence length, vocabulary difficulty, and structural intricacy.

The term “tense” refers to a grammatical category of time reference in the generated language, such as past, present, or future forms of verbs.

The term “emotional intensity of expressions” refers to a degree of emotional emphasis or enthusiasm in the generated text, such as neutral, moderately enthusiastic, or highly passionate expression.

The term “generative AI model” refers to an artificial intelligence model configured to generate information in response to input data, the model being based on machine learning techniques including at least deep learning and natural language processing, and capable of producing natural-language text according to provided prompts.

The term “personalized information” refers to generated information in which content and expression style are adjusted based on user attributes so as to be tailored to an individual user.

The term “post-processing” refers to one or more operations performed on generated personalized information after output from the generative AI model, including at least checking and adjusting expression style, enforcing safety policies, modifying length, and formatting for display.

The term “display format” refers to a data structure or layout suitable for presentation on a display device, including arrangement of text, headings, and other visual elements for rendering by a terminal.

The term “information terminal” refers to an electronic device capable of communicating with the server and presenting information to a user, such as a mobile terminal, a portable information apparatus, or a wearable display device.

The term “communication path” refers to a physical or logical communication channel, including wired or wireless networks and associated protocols, through which data is transmitted between the server and an information terminal.

The term “viewing operation information” refers to data representing user operations related to viewing generated information on the information terminal, including at least movement amount of a display area, scroll operations, zoom operations, and viewing durations.

The term “reaction information” refers to data representing explicit or implicit responses of the user to the generated information, including at least selection operations, save operations, share operations, and other interaction events indicating user interest.

The term “movement amount of a display area” refers to a quantitative indication of how far a displayed content region has been scrolled or otherwise moved on the screen during viewing.

The term “dwell time” refers to a duration during which a particular content item, section, or screen remains visible or is viewed by the user on the information terminal. The term “selection operation” refers to an operation by which a user selects or activates a content element, such as tapping a link, pressing a button, or choosing an option associated with the generated information.

The term “save operation” refers to an operation by which a user stores or bookmarks the generated information or a portion thereof for later access.

The term “share operation” refers to an operation by which a user transmits or exposes the generated information or a portion thereof to another user or service, such as via messaging or social platforms.

The term “weighting” refers to an assignment of relative importance values or coefficients to elements of user attributes, such as fields of interest or style preferences, used in calculations that influence subsequent personalization processing.

The term “update the user attributes” refers to a process in which the system modifies one or more elements of the user attributes, including at least recalculation of weightings for fields of interest, preferences for expression style, and preferences for level of comprehension difficulty, based on newly collected viewing operation information and reaction information.

In one embodiment, a server executes a computer program that implements the claimed system using general-purpose computing hardware and specific software components. The server includes at least one central processing unit, a main memory, one or more non-transitory storage devices, and a network interface. The server operates under a general-purpose operating system such as a UNIX-based or LINUX-based system. The server communicates with one or more terminals via a packet-based network such as the Internet. Each terminal includes a processor, a memory, a display device, an input device such as a touch panel, and a communication module, and executes an application such as a web browser or a native client application.

The server stores, in a storage device, usage history information and attribute information associated with multiple users. The server uses a database management system such as a relational database system or a document database to persist user data. The server defines specific data structures for storing user-related data. For example, the server maintains a user table that contains a user identifier, profile fields, default language settings, and flags indicating consent to personalization. The server further maintains a history table that stores, for each content access, at least a content identifier, a category identifier, a timestamp, a scroll depth value, and a dwell time value. The server also maintains an attribute table that stores, for each user, a set of normalized user attributes, including a primary field of interest, a secondary field of interest, a preference for an expression style, a preference for a language style, and a preference for a level of comprehension difficulty, each expressed as numerical vectors or categorical codes.

The server executes a preprocessing module implemented, for example, in a programming environment such as a scripting language runtime or a managed language runtime. The server uses data-processing libraries such as tabular data processing libraries and numerical computation libraries to process raw usage history information. The server converts timestamps into standardized time zones, groups records by content category, and computes, for each category, a weighted score based on a combination of dwell time, scroll depth, and recurrence frequency. The server expresses these scores as a numerical vector, where each dimension corresponds to a content category, and the value indicates the weighted interest level. The server determines a primary field of interest as the category with the maximum weighted score and determines one or more secondary fields of interest as categories with scores exceeding a threshold relative to the maximum. The server stores these determinations as identifiers and associated weight values in the attribute table.

The server extracts preferences for expression style and language style by analyzing historical responses and reaction information. The server aggregates counts of reactions such as save operations and share operations for articles labeled with different tone types and dialect types. The server normalizes these counts by total interactions and stores them as probability-like weight values. The server thus defines a preference vector for expression style, where each component corresponds to a tone type such as “formal,” “casual,” “friendly,” or “strict.” Similarly, the server defines a preference vector for language style, where each component corresponds to a regional language style such as a standard dialect or a regional dialect. The server defines a comprehension difficulty preference based on the average sentence length and vocabulary level of content that retains longer dwell times. The server encodes sentence length distributions and lexical difficulty metrics as numerical values and maps them to discrete levels such as “plain,” “intermediate,” or “technical.”

The server constructs a prompt sentence using a prompt-construction module. The server converts the normalized user attributes and generation conditions into a structured natural language instruction. The server uses a string template with placeholder segments for each attribute dimension. For example, the server fills a segment describing the primary field of interest, a segment describing the secondary field of interest, a segment describing the tone, a segment describing the regional language style, a segment describing the level of comprehension difficulty, and a segment describing the time range and information amount.

The server outputs a prompt sentence such as: “The user mainly reads technology and gaming articles. The user prefers a friendly and soft tone with a regional dialect, and likes plain and easy-to-understand sentences. Please generate an approximately 800-word news article about the latest smartphone processor technologies and how they affect mobile gaming performance. Use past tense for events that already happened, and keep the style warm and approachable.”

In another example, the server outputs a prompt sentence such as:

“The user is a 35-year-old reader who frequently reads finance and investment articles and prefers formal and concise language without slang. Please generate a 1,000-word article explaining recent global interest rate changes and their impact on personal investment strategies. Use a neutral and professional tone, define technical terms in simple language, and use past tense for completed economic events.”

In still another example, the server outputs a prompt sentence such as: “The user is passionate about sports, especially soccer, and likes enthusiastic and emotional expressions in casual language. Please generate a 700-word article that passionately summarizes yesterday's major soccer matches, highlighting key players, dramatic goals, and turning points. Use past tense to describe the matches and maintain an excited, energetic style throughout the article.”

The server applies a generative AI model that is implemented as a neural network-based language model. In one embodiment, the server deploys a transformer architecture comprising an embedding layer, multiple self-attention layers, feed-forward layers, and an output projection layer. The server stores model parameters as weight matrices in non-volatile storage and loads them into main memory for inference. The server configures the generative AI model to accept as input a tokenized version of the prompt sentence, optionally combined with special tokens encoding user attributes as additional context. The server uses an attention mechanism that computes attention scores based on query, key, and value vectors derived from the input tokens. The server computes, for each layer, a set of output vectors representing contextualized token embeddings. The server then uses a decoding algorithm such as greedy decoding, beam search, or sampling, controlled by parameters such as temperature and top-k or top-p conditions, to sequentially generate tokens representing the personalized information.

The server explicitly binds separate descriptive elements of the prompt sentence to different segments of the token sequence. For example, the server may insert special markers around the segment specifying the primary and secondary fields of interest, and around the segment specifying tone and regional language style. The server can optionally fine-tune the generative AI model using training data where these segments are labeled, so that the model learns to associate specific segments with corresponding style and content features. The server uses a loss function such as a cross-entropy loss over the token sequence, and updates model weights using gradient-based optimization methods such as stochastic gradient descent or adaptive moment estimation during training. The server performs data augmentation in training by varying tone descriptors, regional style descriptors, and complexity descriptors for the same content topic, thereby teaching the model to change linguistic realization while preserving content semantics.

The server integrates the generative AI model into the system architecture via an inference module. The server sends the constructed prompt sentence and encoded user attributes to the inference module, which runs on the same machine or on a dedicated accelerator node that includes graphics processing units or tensor processing units. The server applies batch processing of prompts when multiple user requests are queued, thereby improving throughput and reducing per-request overhead. The server caches frequently used token embeddings and intermediate attention states when similar prompts are repeated, which reduces redundant computation and contributes to faster response times.

The server performs post-processing on the generated personalized information. The server uses a natural language processing library to segment the generated text into sentences and paragraphs. The server verifies that the generated text includes a sufficient number of mentions of the primary and secondary fields of interest based on keyword matching and semantic similarity measures. The server checks style conformity by measuring average sentence length and using a part-of-speech tagger to estimate lexical complexity. If the estimated complexity deviates from the preferred level beyond a threshold, the server adjusts by splitting long sentences, replacing rare words with common synonyms, or truncating overly complex segments. The server also applies a safety filter implemented as a sequence classifier trained to detect categories of disallowed content. The server reprocesses or discards outputs that are classified as violating predefined safety policies.

The server formats the final text into a display format. The server wraps the text with markup tags or structures it into title, subtitle, and body components. The server computes metadata such as estimated reading time based on word count and average reading speed. The server stores the resulting document in an internal representation, such as a serialized object, and transmits it to the terminal via a secure communication protocol such as an encrypted transport protocol.

The terminal receives the formatted personalized information and renders it on a display device. The terminal parses the received document structure and maps the title, body, and metadata to corresponding user-interface components. The terminal draws the text using a rendering engine, and allows the user to scroll vertically or horizontally by manipulating the touch panel or input device. The terminal records, in a local buffer, quantitative values representing viewing operation information, including a time duration while a given article remains at least partially visible on the display, a cumulative scroll offset, and timestamps of selection, save, or share operations. The terminal transmits these values back to the server as reaction information.

The server receives the viewing operation information and reaction information and updates the user attributes. The server aggregates new interaction events with past records to recalculate the weighting of the primary and secondary fields of interest. The server uses a time-decay function to give more importance to recent interactions than to older ones, and updates the attribute table accordingly. The server adjusts the expression style preference vector and language style preference vector by incrementally updating counts or probabilities associated with interaction outcomes for different style labels. For example, when a user repeatedly saves or shares content generated with a particular tone and regional language style, the server increases the weight of that style combination. When the user quickly leaves or scrolls past content with another style, the server decreases its weight. The server recalculates the comprehension difficulty preference by monitoring correlations between dwell time and complexity scores derived from content characteristics. The server then stores the updated user attributes and uses them in subsequent prompt construction, thereby dynamically adjusting the configuration of the generative AI model for each user over time.

The server thus implements a feedback loop that is not limited to human-like manual selection but utilizes quantitative behavioral signals in a non-conventional computational way. The server computes interest and style weights using specific numerical functions and vector operations, and inserts these computed values into structured prompt sentences. This structure allows the server to use the generative AI model as a controllable component, where content topics, tone, dialect, and complexity can be simultaneously and reproducibly adjusted. By explicitly separating descriptive elements in the prompt sentence, the server enables the generative AI model to interpret each element as a distinct condition in the generation process, which is different from simply asking for generic personalized content.

The system exhibits technical effects that improve computer technology. The normalization of user attributes into compact vectors reduces the size of data that must be transmitted and processed, thereby reducing communication bandwidth and memory usage. The structured prompt design and caching of embeddings enable the server to reuse partial computations across similar requests, resulting in improved processing speed. The explicit modeling of user preferences as numerical weights and coded descriptors leads to more stable and accurate personalization, which reduces the need for repeated trial-and-error generations and lowers unnecessary computational load. The feedback loop using detailed viewing and reaction events allows the server to adapt the generative AI model's effective behavior automatically based on mathematical updates of attribute weights, which would be impractical to implement manually.

In alternative embodiments, the server uses different types of generative AI models, such as encoder-decoder architectures or recurrent neural networks enhanced with attention. The server may encode user attributes not only as text segments within the prompt sentence but also as separate embedding vectors concatenated with token embeddings or used to modulate attention weights. The server may store attribute vectors in a vector database and perform similarity search to identify users with similar profiles, thereby enabling collaborative fine-tuning of attribute updates. The server may also modify decoding parameters, such as temperature or repetition penalties, based on user attributes to further control the style and variability of generated text.

In another variation, the terminal performs part of the preprocessing of viewing operation information. The terminal can compute summary statistics such as total dwell time per content item or per session and send only aggregated values to the server, thereby reducing communication traffic. In yet another variation, the system uses edge caching on intermediate nodes to store commonly accessed personalized templates, while still allowing the server to inject final user-specific stylistic adjustments. These variations maintain the core concept of extracting normalized user attributes, encoding them into structured prompt sentences, and using a generative AI model under explicit multi-dimensional control, while providing different trade-offs between computation on the server and on the terminal.

Through these embodiments, the server, the terminal, and the user cooperate in a technical system where data structures, algorithms, and neural network configurations are arranged to achieve efficient, controllable, and adaptive generation of personalized information. The system does not merely automate a human editor's task but implements non-traditional computational procedures, such as vector-based preference modeling, structured prompt encoding of multiple style dimensions, and algorithmic feedback learning from fine-grained interaction data, thereby improving processing speed, accuracy of personalization, and resource efficiency in a manner grounded in computer technology.

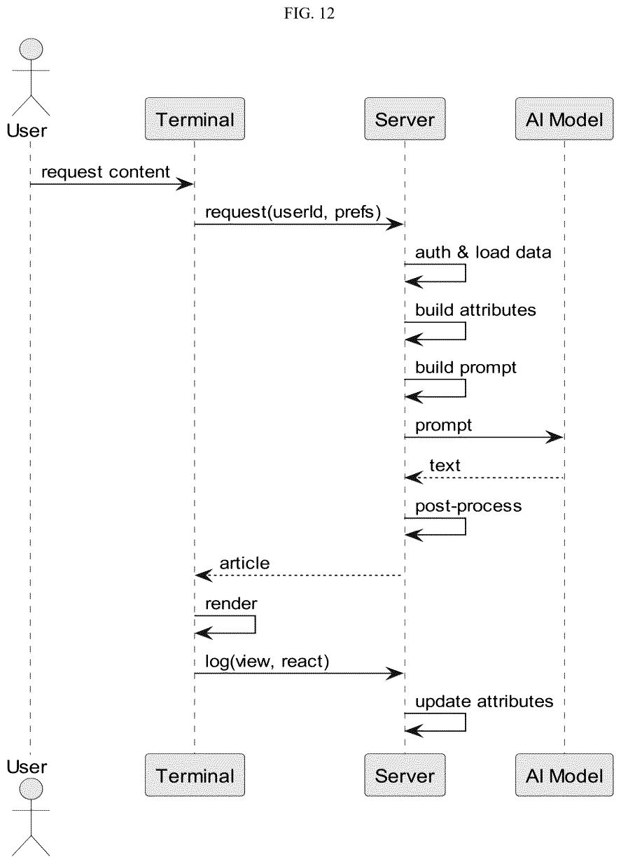

The following describes the processing flow using FIG. 12.

Step 1:

The user operates the terminal to request personalized information.

The user taps a button or opens a screen in an application running on the terminal.

Input: A user action such as a tap or click on a “Get personalized article” control.

Output: A request context in the terminal including at least a user identifier, a session token, language settings, and optional topic preferences.

The terminal converts the user action into a structured request object and stores the user identifier and context values in memory to be attached to a network request.

Step 2:

The terminal transmits a personalization request to the server.

Input: The request context generated in Step 1.

Output: A network message containing the user identifier, session information, device information, and optional requested topic category sent to the server.

The terminal uses an HTTP client library to construct an HTTPS POST or GET request, encodes the request context in JSON or another structured format, and sends the request to a server endpoint.

Step 3:

The server authenticates and validates the received request.

Input: The network message from the terminal containing the user identifier and session information.

Output: A validated request context or an error response.

The server checks the session token against an authentication module, verifies that the user identifier exists in a user table, and checks that all required fields are present and correctly formatted. The server discards malformed requests and, for valid requests, stores the validated context in server-side memory for subsequent processing.

Step 4:

The server retrieves usage history information and attribute information for the user from a storage device.

Input: The validated user identifier from Step 3.

Output: Raw usage history records and raw attribute records associated with the user.

The server executes database queries against a history table and a profile table, obtains records such as content identifiers, categories, timestamps, dwell times, scroll depth values, reaction events, and profile attributes, and loads them into in-memory data structures such as arrays or dictionaries for further computation.

Step 5:

The server normalizes the retrieved data and generates user attributes.

Input: The raw usage history records and raw attribute records from Step 4.

Output: A normalized user attribute representation including at least a primary field of interest, one or more secondary fields of interest, a preference for an expression style, a preference for a language style, and a preference for a level of comprehension difficulty.

The server groups history entries by category, computes weighted interest scores using a function that combines dwell time, scroll depth, and recurrence counts, and identifies the highest-scoring category as the primary field of interest. The server identifies categories above a threshold as secondary fields. The server counts reaction events for different tone labels and regional language labels, normalizes these counts to obtain probability-like weights, and records them as preference vectors. The server estimates comprehension difficulty preference by calculating average sentence length and lexical complexity for previously consumed content and mapping these metrics to discrete difficulty levels. The server stores the resulting attributes as a compact vector or structured record.

Step 6:

The server determines content generation conditions based on the user attributes and the request context.

Input: The normalized user attributes from Step 5 and the validated request context from Step 3.

Output: A generation condition object specifying an information field, a target length, a time range, and emphasis on primary and secondary fields of interest.

The server selects a main information field equal to the primary field of interest or to an explicitly requested topic, chooses one or more subtopics based on secondary fields, sets a target token or word count according to device type and user history, and specifies a time window such as “today,” “this week,” or “recent months.” The server packages these parameters into a condition structure.

Step 7:

The server constructs a prompt sentence for the generative AI model.

Input: The normalized user attributes from Step 5 and the generation condition object from Step 6.

Output: A natural-language prompt sentence that explicitly encodes content and style requirements.

The server fills a template with fields describing the user's interests, tone preference, regional language style preference, comprehension difficulty preference, length target, and time frame. The server concatenates these segments into a single instruction string. For example, the server constructs a prompt sentence such as:

“The user mainly reads technology and gaming articles. The user prefers a friendly and soft tone with a regional dialect, and likes plain and easy-to-understand sentences. Please generate an approximately 800-word news article about the latest smartphone processor technologies and how they affect mobile gaming performance. Use past tense for events that already happened, and keep the style warm and approachable.”

The server stores this prompt sentence as a string ready for model input.

Step 8:

The server encodes the prompt sentence and user attributes for input to the generative AI model.

Input: The prompt sentence from Step 7 and the normalized user attributes from Step 5.

Output: Encoded model input data including token indices and optional attribute embeddings.

The server uses a tokenizer to split the prompt sentence into tokens and map each token to an integer index. The server optionally transforms the user attribute vector into an embedding vector using a learned projection matrix. The server combines the token indices and attribute embeddings into a sequence or a set of tensors according to the generative AI model's input specification.

Step 9:

The server invokes the generative AI model to generate personalized information.

Input: The encoded model input data from Step 8.

Output: A sequence of output tokens representing the generated personalized text.

The server loads the generative AI model parameters into memory and uses a neural network inference engine to compute output logits for each token position. The server applies an attention mechanism over the encoded token and attribute representations in each transformer layer, propagates activations forward through feed-forward layers, and executes a decoding algorithm such as beam search or sampling to select the most probable next token at each step. The server repeats this decoding until a stop condition is met, building a sequence of output token indices.

Step 10:

The server decodes and post-processes the generated output text.

Input: The sequence of output token indices from Step 9.

Output: A post-processed text string formatted for display.

The server converts token indices back into characters and words to obtain a raw generated text. The server uses sentence segmentation to divide the text into sentences and paragraphs. The server computes average sentence length and vocabulary rarity scores and compares them against the user's preferred comprehension level. The server splits or merges sentences and replaces rare words with more common synonyms when complexity deviates from the preferred range. The server applies a safety classifier to detect disallowed categories and removes or edits segments if necessary. The server adds simple structure, such as a title line and paragraph breaks, and produces a final formatted text string.

Step 11:

The server packages the formatted text with metadata and transmits it to the terminal.

Input: The formatted text string from Step 10 and the generation condition object from Step 6.

Output: A response message that includes the personalized article, metadata, and status information delivered to the terminal.

The server attaches metadata such as article title, primary category, secondary category, estimated reading time, and generation timestamp. The server encodes this information and the text body into a structured response, sets appropriate headers, and sends the response over a secure communication channel to the terminal.

Step 12:

The terminal receives and renders the personalized information.

Input: The response message from Step 11.

Output: A displayed article on the terminal's display device.

The terminal parses the response, extracts the article text and metadata, and maps them to user interface elements such as a title label and a scrollable text area. The terminal uses its rendering engine to draw the content on the screen and initializes event listeners to detect scrolling, tapping, saving, and sharing actions. The terminal presents the personalized article to the user for viewing.

Step 13:

The user reads and interacts with the displayed article on the terminal.

Input: The rendered article view from Step 12.

Output: Interaction events such as scroll movements, dwell time measurements, selection operations, save operations, and share operations.

The user scrolls through the article, may tap on interface elements like “save” or “share,” or may leave the page. The terminal records the time intervals between entering and leaving the screen, calculates total dwell time and maximum scroll depth, and logs each button press as a distinct event type.

Step 14:

The terminal aggregates interaction events and sends viewing operation information and reaction information to the server.

Input: The raw interaction events generated in Step 13.

Output: An analytics message containing aggregated viewing operation information and reaction information.

The terminal groups events by content identifier, computes summary values such as total dwell time, maximum scroll offset, and counts of save and share operations, and formats these values into a compact structure. The terminal periodically transmits this analytics message to the server via a background network request.

Step 15:

The server updates the user attributes based on the received interaction data.

Input: The analytics message from Step 14 and the existing user attributes from Step 5.

Output: Updated user attributes with recalculated weights for fields of interest, expression style preferences, language style preferences, and comprehension difficulty preference.

The server parses the analytics message, associates the interaction metrics with corresponding content categories and style labels, and updates interest scores using a time-decay weighted averaging function. The server increases weights for categories and styles associated with longer dwell time and more positive reactions, and decreases weights for those with low engagement. The server recomputes the primary and secondary fields of interest and adjusts the preference vectors and difficulty level. The server writes the updated user attributes back to the attribute table, making them available for use in constructing future prompt sentences and for guiding subsequent invocations of the generative AI model.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information delivery systems that use generative AI models typically apply static or coarse-grained user profiles when generating content. In many such systems, a server merely selects a topic or a language based on a simple user attribute, and then forwards a basic prompt sentence to a generative AI model. The generative AI model generates content without detailed control of linguistic style, dialect usage, strength of expression, sentence complexity, or tense. As a result, the generated content often fails to match subtle user preferences such as regional language characteristics, preferred politeness level, tolerance for technical terminology, or preferred content length. This mismatch leads to reduced user engagement and requires repeated manual tuning of prompts and system parameters by developers or operators.

Furthermore, in existing architectures, behavioral history obtained from a user terminal, such as scrolling behavior or reading completion time, is not tightly integrated into the core computational pipeline that constructs the prompt sentence for the generative AI model. Behavioral history may be stored as logs for later analytics, but it is rarely used in real time to update user attributes and to refine the internal parameters that govern prompt generation and post-processing. This results in systems that are slow to adapt, that waste computational resources on generating content that is not well targeted, and that do not efficiently exploit available data to improve the operation of the underlying computer components.

Still further, conventional systems often treat generative AI output as final content, with little or no automated post-processing. When post-processing is performed, it is frequently implemented as separate ad-hoc scripts that are not integrated with the generative AI pipeline itself, causing duplicated processing, increased latency, and inconsistent quality. These systems do not provide a systematic mechanism for using both rule-based post-processing and a secondary generative AI pass to normalize style, refine vocabulary, and adjust tense and sentence length, based on continuously updated user attributes. From the perspective of computer technology, this leads to inefficient use of processor and network resources, as well as non-optimized data flows and state management.

Therefore, there is a need for an improved computer-implemented system that (i) programmatically analyzes behavioral history information and attribute information of a user to extract fine-grained user attributes, (ii) automatically converts these attributes into structured internal parameters and prompt sentences for a generative AI model, (iii) applies a unified and configurable post-processing pipeline, including a possible secondary generative AI rewriting step, and (iv) continuously updates and relearns user attributes based on viewing operation information from a user terminal. Such a system should improve the technical functioning of the server by optimizing prompt generation, reducing unnecessary generative AI calls, improving the relevance and structure of generated content, and efficiently managing data flows and model interactions.

The specific processing by the specific processing unit 290 of the data processing device 12 in Example 2 is realized by the following means.

The present invention provides a server comprising a processor configured to read, from a storage device based on user identification information received via a communication network, behavioral history information and attribute information of a user, analyze the behavioral history information and the attribute information to extract user attributes including at least a region of the user, a language style, a necessity of dialect use, a preferred field, a strength of expression, a sentence complexity, and a tense preference, determine internal parameters that define conditions relating to a subject of information content, an amount of information, a used language, a used dialect, a writing style, a strength of expression, and a tense, in accordance with the extracted user attributes, generate a prompt sentence to be input to a generative AI model based on the internal parameters and template information stored in advance, transmit the generated prompt sentence to an information generation apparatus including the generative AI model via a communication interface, acquire information content generated by the generative AI model in accordance with the user attributes, apply, to the acquired information content, post-processing rules or a rewriting process using the generative AI model so as to reflect user preferences relating to strength of expression, politeness, tolerance of technical terms, and sentence length, and thereby generate customized information in which vocabulary, sentence-ending expressions, sentence length, and tense of the information content are adjusted, and transmit the customized information to a user terminal, update the behavioral history information based on viewing operation information for the customized information received from the user terminal, and, based on the updated behavioral history information, relearn the user attributes so as to automatically optimize, for subsequent processing, the prompt sentence and the customized information to be generated. This enables an improvement of computer functionality by providing a server-side processing pipeline that dynamically transforms user interaction data into structured model control parameters and refined prompt sentences, reduces computational waste by tailoring generative AI model invocation and post-processing to finely characterized user attributes, enhances the efficiency and responsiveness of content generation through iterative relearning of user attributes based on real-time viewing operation information, and yields more relevant and structurally optimized output data that can be transmitted and rendered by the user terminal with reduced need for manual adjustment or external processing.

The term “processor” refers to a hardware or virtual processing unit, including a central processing unit or similar computational circuitry, configured to execute instructions for analyzing data, generating prompt sentences, communicating with external components, and performing post-processing to generate customized information.

The term “storage device” refers to a hardware component or subsystem, such as a memory device or a non-volatile storage medium, configured to store behavioral history information, attribute information, template information, internal parameters, and generated information content.

The term “communication network” refers to a wired or wireless communication infrastructure, including at least one of the internet, a local area network, or a mobile communication network, through which data is exchanged between the server, an information generation apparatus, and a user terminal.

The term “user identification information” refers to information that enables a system to distinguish one user from another, including at least one of a user ID, a session ID, a device ID, a cookie, or an authentication token.

The term “behavioral history information” refers to data representing past interactions of a user with content or a service, including at least one of viewed content records, access timestamps, navigation paths, viewing completion times, scrolling operations, selection operations, and evaluation operations.

The term “attribute information” refers to data representing characteristics of a user, including at least one of region information, language preference, topic preference, expression preference, and prior configuration settings stored for that user.

The term “user attributes” refers to structured information extracted by analysis of behavioral history information and attribute information, including at least a region of the user, a language style, a necessity of dialect use, a preferred field, a strength of expression, a sentence complexity, and a tense preference.

The term “region of the user” refers to information indicating a geographical area associated with the user, including at least one of a country, a region, a prefecture, a state, or a locality, which may influence language style or dialect usage.

The term “language style” refers to characteristics of linguistic expression preferred by the user, including at least one of formal style, informal style, polite style, casual style, soft expression, and strong expression.

The term “necessity of dialect use” refers to an attribute indicating whether a regional dialect or localized linguistic form should be used, avoided, or optionally applied in generated information content for a user.

The term “preferred field” refers to a content category or topic area favored by the user, including at least one of news, weather, law, sports, technology, entertainment, or other subject domains.

The term “strength of expression” refers to the relative intensity or forcefulness of wording in generated content, including at least soft expressions, neutral expressions, and strong expressions.

The term “sentence complexity” refers to the structural complexity of sentences in generated content, including at least the use of short simple sentences, compound sentences, and complex sentences.

The term “tense preference” refers to a preferred temporal form for describing events in generated content, including at least present tense, past tense, and future tense.

The term “internal parameters” refers to structured control values determined in accordance with user attributes, the control values specifying conditions relating to at least a subject of information content, an amount of information, a used language, a used dialect, a writing style, a strength of expression, and a tense.

The term “subject of information content” refers to a main topic or theme to be addressed in the information generated for a user, such as a specific event, domain, or question.

The term “amount of information” refers to a quantity or depth of content to be generated, including at least a brief summary, a medium-length explanation, and a detailed description.

The term “used language” refers to a natural language selected for generating content, including at least one of a first language, a second language, or a multilingual combination.

The term “used dialect” refers to a regional or localized variant of a natural language used in generated content, determined in accordance with region and preference of the user.

The term “writing style” refers to a pattern of written expression determined by the system, including at least one of narrative style, explanatory style, instructional style, and conversational style.

The term “template information” refers to pre-stored data structures or text patterns used as a basis for constructing prompt sentences or content, the data structures or text patterns including at least placeholders for internal parameters and fixed text segments.

The term “prompt sentence” refers to a natural language instruction or set of instructions provided as input to a generative AI model, the instruction specifying at least conditions relating to subject, style, tone, dialect, length, and tense of information to be generated.

The term “generative AI model” refers to a trained machine learning model configured to generate natural language text or similar content in response to a prompt sentence, based on learned parameters obtained from training data.

The term “information generation apparatus” refers to a computing system or service including the generative AI model and associated processing components, configured to receive a prompt sentence and output generated information content.

The term “information content” refers to data generated by the generative AI model in response to a prompt sentence, including at least natural language text that conveys information to be delivered to the user.

The term “post-processing rules” refers to computer-implemented rules applied to generated information content, including at least rule-based transformations, string replacements, and structural modifications to adjust vocabulary, sentence endings, sentence length, and tense.

The term “rewriting process using the generative AI model” refers to a process in which the generated information content is provided back to a generative AI model with an additional prompt sentence to obtain a revised version of the content that satisfies specified style or dialect constraints.

The term “customized information” refers to information content that has been adjusted based on user attributes and user preferences, including at least modifications to vocabulary, sentence-ending expressions, sentence length, and tense.

The term “user terminal” refers to an endpoint device operated by a user, including at least a smartphone, a tablet, a personal computer, or another computing device capable of communicating with the server and displaying customized information.

The term “viewing operation information” refers to data indicating how a user interacts with displayed customized information on a user terminal, including at least viewing completion time, scrolling operation, selection operation, and evaluation operation. The term “relearn the user attributes” refers to updating user attributes by analyzing newly collected behavioral history information and viewing operation information, thereby refining weights and parameters used for subsequent prompt generation and content customization.

The term “weighting parameters” refers to numerical or categorical values computed for each user, representing levels of preference relating to at least topic field, language style, dialect, strength of expression, and amount of information, the values being used to influence generation of prompt sentences and customized information.

The server implements the invention as a network-connected computing system including a processor, a main memory, a non-volatile storage device, and a communication interface. The server executes an operating system such as a general-purpose server operating system and one or more application programs implementing user attribute analysis, prompt sentence generation, interaction with a generative AI model, and post-processing of generated content. The server stores behavioral history information, attribute information, template information, internal parameters, and generated information content in the storage device, which may be a solid-state drive or magnetic disk.

The terminal operates as a user-facing device such as a smartphone, tablet, or personal computer, equipped with a display, an input interface, a communication interface, and an execution environment for a web browser or a native application. The terminal transmits user identification information and viewing operation information to the server via a communication network, and displays customized information received from the server on the display.

The user operates the terminal by performing actions such as launching an application, selecting content, scrolling through displayed content, and inputting evaluations or preferences. The user thereby generates interaction data that the terminal collects and transmits to the server as behavioral history information and viewing operation information.

The server stores behavioral history information and attribute information in a structured form in the storage device. The server uses a data model in which each user is associated with records containing fields such as a user identifier, region information, language preference, topic preference, expression preference, and a log of previously viewed content. The server represents the behavioral history as a time-ordered list or table, where each entry includes a content identifier, access timestamp, viewing duration, scroll depth, interaction type, and optional evaluation score.

The server reads the behavioral history information and the attribute information from the storage device based on the user identification information received from the terminal. The server loads the data into the main memory and executes analysis routines implemented in an application framework. The server uses numerical and categorical feature extraction methods to convert the raw records into a feature vector for each user. For example, the server encodes a region of the user as a categorical variable, encodes a preferred field as a distribution over topic categories, encodes a language style as a combination of attributes such as politeness level and formality, and computes aggregate statistics such as average viewing time per topic and average scroll depth per content length.

The server determines user attributes by applying a combination of rule-based logic and statistical computation. The server applies thresholds and weighting functions to behavioral history metrics to derive a strength of expression preference, a sentence complexity preference, and a tense preference. For instance, the server may compute a higher weight for short content when the user frequently exits long articles early, and interpret this as a preference for simpler sentences and shorter content. The server stores the derived user attributes as a compact user profile structure, such as an array of numerical scores and categorical codes, which the server can access efficiently when generating a prompt sentence.

The server determines internal parameters that define conditions relating to a subject of information content, an amount of information, a used language, a used dialect, a writing style, a strength of expression, and a tense. The server maps user attribute values to internal parameters by using a transformation function. For example, the server converts a region attribute into a dialect flag, converts topic weights into a selected subject, converts complexity scores into an amount of information level, and converts politeness and intensity scores into a writing style and strength of expression. The server represents the internal parameters as a structured data object containing fields such as “subject,” “length_level,” “language_code,” “dialect_code,” “style_code,” “intensity_level,” and “tense_code.”

The server generates a prompt sentence for a generative AI model based on the internal parameters and template information stored in advance. The server stores template information as a collection of text patterns with placeholders corresponding to internal parameters. The server retrieves a template corresponding to the subject and language specified in the internal parameters, and performs string substitution to fill the placeholders with concrete values. The server thereby constructs a natural language instruction that includes explicit conditions for the generative AI model regarding topic, style, dialect, length, and tense.

The server may generate prompt sentences such as:

“Please generate a short and easy-to-understand weather forecast article in Japanese for a user from the Kansai region. Use Kansai dialect, and keep the tone soft and friendly. Focus on tomorrow's weather and give practical advice such as carrying an umbrella or choosing clothes.”

“Please generate a specialized article about contract drafting for a user who is interested in law. Use formal expressions, avoid slang, and provide practical examples related to commercial contracts. Keep sentences clear but allow technical legal terminology where appropriate.”

“Rewrite the following article using polite and soft expressions in Japanese, without changing the meaning. Shorten long sentences where possible, and avoid complex technical terms. The article is intended for a non-expert reader.”

The server transmits the generated prompt sentence to an information generation apparatus including the generative AI model via the communication interface. In one embodiment, the server sends the prompt sentence to a separate computing system over a secure transport protocol. The information generation apparatus includes a hardware platform with at least one graphics processing unit or other accelerator, and executes a neural network-based generative AI model.

The generative AI model may be implemented as a transformer-based neural network with multiple self-attention layers, feed-forward layers, and layer normalization components. The model uses token embeddings to represent input text tokens, positional encodings to maintain sequence order, and multi-head attention mechanisms to compute contextualized representations for each token. The model has been trained on a large corpus of text data using an autoregressive training objective, where the model predicts the next token in a sequence based on previous tokens. The training process employs a loss function such as cross-entropy loss, and the model parameters are updated by gradient descent or a variant such as Adam. During training, the model adjusts weight matrices in the attention and feed-forward layers to minimize prediction error on the training data, thereby learning patterns of language usage, syntax, and semantics.

The server configures the generative AI model at inference time by specifying parameters such as a maximum number of output tokens, a temperature parameter controlling randomness, and a top-p or top-k sampling parameter controlling token selection. The server embeds the prompt sentence as token identifiers and transmits them to the information generation apparatus. The generative AI model computes output token probabilities through the transformer layers and generates a sequence of output tokens that represent the information content. The information generation apparatus returns the generated text to the server as a sequence of characters or tokens.

The server acquires the information content generated by the generative AI model and stores it temporarily in memory. The server then applies post-processing rules or a rewriting process using the generative AI model so as to reflect user preferences relating to strength of expression, politeness, tolerance of technical terms, and sentence length. The server may use deterministic post-processing rules such as pattern matching, synonym substitution, sentence splitting, and tense conversion. For example, the server can scan for strong expressions and replace them with milder alternatives, convert certain verb forms to past tense, or replace specialized terms with explanatory phrases.

The server may also apply a secondary generative AI rewriting process. In such a case, the server constructs an additional prompt sentence that includes the generated information content as input text and instructs the generative AI model to rewrite the content according to specified style constraints. The server sends the additional prompt sentence and the original content to the generative AI model, which then outputs rewrite information, that is, a revised version of the text. For example, the server may use the following secondary prompt:

“Rewrite the following text in softer and more polite Japanese, while preserving the original meaning. Keep sentences short and easy to understand, and remove unnecessary technical jargon.”

The server then adopts the rewritten content as customized information. In this way, the server uses the generative AI model not only for initial content generation but also as a transformation engine that refines content according to user-specific stylistic preferences that are encoded in the internal parameters and user attributes.

The server transmits the customized information to the user terminal over the communication network. The terminal receives the customized information and renders it on the display using a user interface implemented by a browser or a native application. The terminal may present the customized information as formatted text, optionally combined with graphical elements. The user reads the content, interacts with the display, and may provide explicit feedback such as ratings or topic selections.

The terminal collects viewing operation information such as viewing completion time, scroll position data, tap or click events, and evaluation inputs. The terminal packages this viewing operation information together with the user identification information and transmits it back to the server. The server receives the viewing operation information and updates the behavioral history information in the storage device. The server merges new entries into the existing log, and recalculates statistics such as average viewing duration, abandonment rate, and topic-specific engagement.

The server relearns the user attributes by applying updated statistical analysis and weighting computation. The server computes weighting parameters for each user relating to topic field, language style, dialect, strength of expression, and amount of information. For example, if the user consistently reads content in a particular field to completion and provides positive evaluations, the server increases the corresponding topic weight. If the user abandons content when strong expressions are used, the server adjusts the strength of expression weight toward softer expressions. The server then updates the internal parameters derived from these user attributes and uses them in subsequent prompt sentence generation.

The server thereby implements a closed feedback loop in which terminal-side interaction data directly influences the parameters controlling generative AI behavior and post-processing. This loop improves computational efficiency because the server increasingly avoids generating content that does not align with user preferences. The server reduces wasted generative AI calls by narrowing the subject and style parameters, and reduces network traffic by lowering the frequency of user-initiated retries. Furthermore, the server improves accuracy of personalization and reduces errors in matching user expectations by continually optimizing the mapping from behavioral signals to internal parameters.

The server improves computer technology rather than simply automating human work. The server introduces specific data structures for user attributes and internal parameters, and implements a non-conventional pipeline in which user interaction signals dynamically modulate the control of a generative AI model. The server organizes data flow from the terminal through the attribute analysis module, the prompt sentence generator, the generative AI interface, the post-processing module, and back to the terminal in a structured and optimized manner. This organization results in reduced processing time for generating relevant content, reduced memory usage through compact representation of attributes and internal parameters, and reduced communication load by delivering content that more closely matches user needs on the first attempt.

The server uses model-specific knowledge of transformer architectures and training methods to align prompt design and post-processing steps with the generative AI model's strengths. For instance, the server uses explicit style and dialect instructions in the prompt sentence to guide attention patterns in the generative AI model, thereby improving the probability that the generated content exhibits the desired style without requiring excessive iterative calls. The server's use of a secondary rewriting pass only when rule-based post-processing fails to meet predefined style thresholds further optimizes the number of model invocations.

The server implements rules and non-conventional procedures that differ from human writing behavior. For example, the server may enforce constraints such as limiting sentence length based on measured reading speed, or automatically adjusting tense based on content metadata. The server performs these adjustments algorithmically using defined thresholds and transformation rules that are applied at scale across many users, in a manner that would be difficult for a human operator to replicate consistently and in real time.

Alternative embodiments are also possible. In one embodiment, the server executes the generative AI model locally on the same hardware system, using a graphics processing unit installed in the server chassis. In another embodiment, the server interacts with multiple generative AI models, selecting one based on subject or language requirements and routing prompt sentences accordingly. The server may use a smaller, specialized model for rewriting operations and a larger, more capable model for initial content generation. In yet another embodiment, the server uses additional feature extraction methods, such as semantic embeddings of previously viewed texts, to refine user attributes and internal parameters. The terminal may also vary. In one embodiment, the terminal is a wearable device with a small display, and the server uses this information to reduce the length of customized information and adjust formatting. In another embodiment, the terminal is an in-vehicle device, and the server generates content optimized for voice output, controlling sentence length and structure to align with speech synthesis constraints.

The user may interact with the system in different ways. In some embodiments, the user explicitly selects preferred styles or dialects in a settings screen on the terminal, and the server incorporates these explicit preferences into the attribute information. In other embodiments, the server infers preferences solely from behavioral history, without explicit user configuration.

In all embodiments, the server, the terminal, and the generative AI model cooperate to form an integrated technical system that transforms user interaction data into improved control signals and refined prompt sentences. This technical arrangement improves the functioning of the computer system as a whole by enabling more efficient utilization of processing resources, reducing unnecessary data transmission, and producing output data that is more compliant with user-specific constraints without manual intervention.

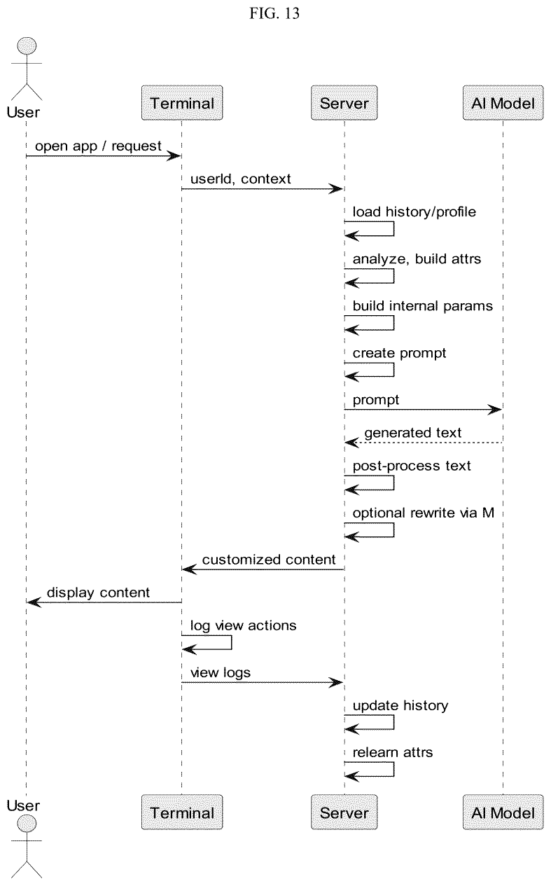

The following describes the processing flow using FIG. 13.

Step 1:

The terminal sends user identification information and current access information to the server.

The terminal uses a browser or an application to generate an HTTPS request including a user ID, device ID, session token, and basic context such as requested screen or content type. As input, the terminal uses locally stored identifiers (for example, cookies or app tokens) and UI state. The terminal performs data formatting into a request body or headers and outputs a network message addressed to the server.

Step 2:

The server receives the request and retrieves behavioral history information and attribute information from a storage device.

The server uses the user identification information as input and performs a database query against tables storing behavioral logs and user profiles. The server executes lookup operations using indexed fields (such as user ID) to efficiently read records containing past viewed content, timestamps, interaction logs, region settings, language preferences, and explicit user settings. The server outputs raw behavioral history information and raw attribute information in structured form in memory.

Step 3:

The server analyzes the behavioral history information and the attribute information to extract user attributes.

The server uses the retrieved records as input and performs feature extraction and aggregation. The server computes statistics such as frequency of topics, average reading time, abandonment rate for long articles, and frequency of interactions with specific styles. The server classifies region based on profile fields, derives language style from explicit settings and historical content types, and determines necessity of dialect use from region and past dialect-tagged content performance. The server applies threshold functions and weighting formulas to generate a compact user attribute set including region of the user, language style, necessity of dialect use, preferred field, strength of expression, sentence complexity, and tense preference. The server outputs a user attribute object representing these attributes as numerical and categorical values.

Step 4:

The server determines internal parameters based on the extracted user attributes.

The server uses the user attribute object as input and performs a mapping from user attributes to control parameters for content generation. The server executes rule-based logic and, optionally, a small parameterized model to select a subject of information content, an amount of information (for example, short, medium, long), a used language code, a used dialect flag, a writing style code, an expression intensity level, and a tense indicator. The server combines these values into an internal parameter structure with fields such as “subject,” “length_level,” “language_code,” “dialect_code,” “style_code,” “intensity_level,” and “tense_code.” The server outputs this internal parameter structure for use in prompt sentence generation.

Step 5:

The server generates a prompt sentence for a generative AI model using template information and internal parameters.

The server uses the internal parameter structure and template information stored in the storage device as input. The server selects a text template corresponding to the subject and language (for example, a weather article template or a legal article template) by evaluating the “subject” and “language_code” fields. The server then substitutes placeholder tokens in the selected template with concrete values from the internal parameters. The server performs string concatenation and formatting operations to construct a natural language instruction. As a result, the server outputs a prompt sentence such as: “Please generate a short and easy-to-understand weather forecast article in Japanese for a user from the Kansai region. Use Kansai dialect, and keep the tone soft and friendly. Focus on tomorrow's weather and give practical advice such as carrying an umbrella or choosing clothes.”

Step 6:

The server sends the prompt sentence to an information generation apparatus including the generative AI model and receives generated information content.

The server uses the generated prompt sentence as input and creates an API request with model configuration parameters such as maximum token length, temperature, and sampling strategy. The server transmits this request over the communication network to the information generation apparatus. The generative AI model processes the prompt sentence, computes token probabilities through its neural network layers, and generates a sequence of output tokens representing the requested content. The server receives the API response as output, parses the response body, and extracts the generated information content as text.

Step 7:

The server performs rule-based post-processing on the generated information content.

The server uses the raw generated text and the user attribute object as input. The server applies a set of post-processing rules, including pattern matching and text substitution, to adjust vocabulary, sentence endings, sentence length, and tense. For example, the server detects overly strong expressions and replaces them with milder synonyms if the user attribute “strength of expression” indicates a preference for soft expressions. The server may split long sentences into shorter ones when the “sentence complexity” attribute indicates a preference for simpler sentences. The server outputs a first-stage adjusted text that conforms more closely to the user's style preferences.

Step 8:

The server determines whether additional rewriting using the generative AI model is necessary and, if needed, executes a secondary rewriting pass.

The server uses the first-stage adjusted text and quality criteria derived from user attributes as input. The server evaluates conditions such as remaining sentence length, presence of technical terms, and politeness markers. If the server determines that the text does not meet predefined thresholds, the server generates an additional prompt sentence that includes the current text and specifies rewriting constraints. For example, the server may form the following prompt:

“Rewrite the following text in softer and more polite Japanese, while preserving the original meaning. Keep sentences short and easy to understand, and remove unnecessary technical jargon.”

The server combines this prompt with the current text and sends it again to the generative AI model. The generative AI model outputs rewrite information, that is, a revised version of the text. The server receives this revised text and uses it as the final customized information. If no additional rewriting is needed, the server uses the first-stage adjusted text as the customized information. The server outputs customized information text ready for delivery.

Step 9:

The server transmits the customized information to the terminal.

The server uses the customized information text as input and wraps it into a response payload appropriate for the terminal type, such as an HTML document or a structured response. The server adds metadata such as language code and content type into headers or fields. The server then sends the response over the communication network to the terminal. The server outputs a network response containing the customized information.

Step 10:

The terminal displays the customized information and records viewing operation information.

The terminal uses the received response as input and parses the payload to extract the customized text and any associated metadata. The terminal renders the text on the display using the browser or application layout engine. While the user reads and interacts with the content, the terminal monitors actions such as scrolling, tap events, time spent on the page, and evaluation inputs. The terminal aggregates these interaction events into viewing operation information, including viewing completion time, scroll depth, selection operations, and evaluation operations. The terminal outputs a viewing operation information record associated with the user identification information.

Step 11:

The terminal sends the viewing operation information to the server.

The terminal uses the collected viewing operation information and the user identification information as input. The terminal packages this data into an HTTPS request, including fields such as content identifier, timestamps, interaction types, and user feedback. The terminal transmits this request to the server over the communication network. The terminal outputs a network message that allows the server to update behavioral history.

Step 12:

The server updates behavioral history information and relearns user attributes.

The server uses the newly received viewing operation information and existing behavioral history information as input. The server appends new entries to behavioral history tables, recalculates aggregated statistics such as average viewing duration per topic and abandonment rates, and updates stored values for topic interest and style preferences. The server then re-executes its user attribute extraction logic, recalculating user attributes and weighting parameters for topic field, language style, dialect, strength of expression, and amount of information. The server outputs updated user attributes and updated internal state, which will be used as input in a subsequent execution of Steps 4 through 8, thereby continuously optimizing prompt sentence generation and customized information production.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content delivery systems typically apply fixed recommendation rules or simple collaborative filtering based on coarse user profiles and past clicks. Such systems treat a generative AI model as a generic text generator that receives a short, static prompt and outputs content without deep integration with dynamic user modeling. As a result, these systems suffer from several technical problems.

First, the systems generally lack a tightly coupled feedback loop between fine-grained usage logs on a user terminal and the generation logic executed on a server. Interaction signals such as viewing time, scroll depth, operation patterns, and in-situ evaluations are either not collected in a structured form or are not fed back to update the parameters that control prompt construction for the generative AI model. This leads to a technically suboptimal use of computation and network resources, because the server repeatedly generates lengthy, ill-targeted content that the user only partially consumes.

Second, conventional architectures do not integrate emotion analysis and user attribute inference into the core control path of prompt generation. Emotion analysis, when used at all, is often applied only at the user interface level or as an auxiliary tag. The generative AI model is not driven by a systematically constructed prompt that simultaneously encodes user interest fields, language expression style, dialect preference, expression strength, sentence difficulty, information density, and current emotional state. Consequently, the server cannot effectively control the generative AI model to output content whose tone, length, structure, and terminology are tuned to the current cognitive and emotional context of the user. This degrades perceived quality and can increase server-side processing load due to unnecessary regeneration and retries.

Third, many existing systems generate content in a single data representation, requiring the client terminal or downstream services to perform additional format conversions. This fragmentation causes redundant computation at the edge, increases data transfer overhead, and complicates caching and reuse of generated content across heterogeneous terminals. Furthermore, the server typically does not track how different formats and presentation structures affect user engagement, and therefore cannot optimize the generation and formatting pipeline as a unified, adaptive process.

Fourth, from a computer technology perspective, there is no mechanism to treat the combination of: (i) multi-source user data acquisition (browsing history, profile, preferences, external documents), (ii) emotion classification with confidence measures, (iii) adaptive prompt sentence generation for a generative AI model, (iv) structured multi-format conversion on the server, and (v) continuous update of user attribute estimates based on usage logs, as an integrated control loop that improves the efficiency and effectiveness of the generative process itself. Without such an integrated loop, the system cannot reduce wasted model inference cycles, cannot systematically adjust prompt content over time, and cannot maintain high-quality personalization under changing user states.

Accordingly, there is a need for a technical solution that improves the functioning of server-side computing resources and generative AI pipeline components by: (1) tightly coupling fine-grained logging and user modeling with prompt generation, (2) embedding emotion-aware and attribute-aware control information into a structured prompt sentence, (3) performing server-side post-processing and multi-format conversion in a unified manner, and (4) adaptively updating prompt-generation parameters based on historical usage logs. By solving these problems, the system can more efficiently utilize machine learning inference resources, reduce unnecessary data transfers, and deliver content that is better aligned with the user's current state, thereby improving overall performance of the computer system.

The specific processing by the specific processing unit 290 of the data processing device 12 in Application Example 2 is realized by the following means.

The present invention provides a server comprising a processor configured to acquire, via a communication interface, data including at least browsing history of a user, attribute information of the user, preference information of the user, document data obtained from an external information source, and information indicating an emotional state of the user; to store the acquired data in a storage medium; to analyze the stored data and identify user attributes including at least an interest field of the user, a language expression style of the user, presence or absence of dialect usage, strength or softness of expressions, difficulty level of sentences, preference regarding an amount of information, and a current emotional state of the user; to generate, based on the identified user attributes and the current emotional state, text data forming a prompt sentence to be input to a generative AI model, the prompt sentence including instruction information that specifies at least a subject of content, a level of detail of information, a writing style, usage of dialect, usage of tense, a tone, and an intensity of emotional expression; to input the generated prompt sentence to the generative AI model and obtain generated information including text information whose content and expression style are adjusted in accordance with the user attributes and the current emotional state, by an inference process using machine learning and natural language processing; to perform post-processing on the obtained generated information such that at least a tone of expression, a selection of terms, a length of sentences, a paragraph structure, and emotional expressions are made compatible with the user attributes and the current emotional state, and to format the post-processed generated information as structured information including title information, body information, and associated metadata; to convert the structured information into a plurality of information display formats including at least a markup data format, a hierarchical data format, and a character-string data format, and to generate delivery data that is transmittable in an information display format selected in accordance with a type of a terminal used by the user; to transmit the delivery data to the terminal of the user via a communication network; and to acquire, from the terminal of the user, a usage log including at least viewing time, operation history, evaluation information, and additional input information relating to a display based on the delivery data, and to update an estimation result of the user attributes and the emotional state based on the usage log. This enables the server to implement an adaptive feedback loop that dynamically controls prompt sentences supplied to the generative AI model, thereby improving utilization efficiency of computational resources, reducing generation of irrelevant or low-engagement content, and enhancing overall performance of the content generation and delivery pipeline in the computer system.

The term “user” refers to an individual or entity that receives content generated by the system and whose data, attributes, preferences, and emotional state are analyzed by the processor.

The term “browsing history” refers to data indicating access records of the user to information resources, including at least identifiers of accessed resources, timestamps, and associated interaction information.

The term “attribute information” refers to data representing characteristics of the user, including at least demographic data, geographic data, registered profile data, and declared or inferred interests.

The term “preference information” refers to data indicating choices or tendencies of the user, including at least preferred topics, preferred presentation styles, preferred language styles, and preferred content length or detail level.

The term “document data” refers to text-based or text-derivable information obtained from an external information source, including at least messages, posts, articles, comments, or other textual content associated with the user.

The term “external information source” refers to any system or service separate from the server that provides document data or other information related to the user, including at least network-based information services or communication services.

The term “emotional state” refers to a psychological condition of the user at a particular time, represented as one or more emotion types, such as joy, sadness, anger, or neutrality, optionally with associated confidence values.

The term “data” refers to digital information processed, stored, or transmitted by the system, including at least text data, numerical data, categorical data, and structured or unstructured records.

The term “storage medium” refers to any hardware component capable of storing data under control of the processor, including at least semiconductor memory, magnetic storage, optical storage, or persistent storage devices.

The term “user attributes” refers to a set of parameters or labels associated with the user, obtained by analysis of stored data, and including at least interest fields, language expression style, dialect usage, expression strength, sentence difficulty level, information amount preference, and current emotional state.

The term “interest field” refers to a category or topic domain toward which the user shows sustained or inferred interest, such as a particular technical field, entertainment area, academic area, or other information domain.

The term “language expression style” refers to a manner of text expression preferred by or appropriate for the user, including at least formality level, conversational style, and typical phrasing patterns.

The term “dialect usage” refers to use or non-use of region-specific language variants, including regionally distinct vocabulary, grammar, or pronunciation reflected in textual form.

The term “expression strength” refers to a degree of intensity or softness of wording in generated text, including at least strong expressions, neutral expressions, and soft expressions.

The term “difficulty level of sentences” refers to a complexity level of text, including factors such as sentence length, vocabulary sophistication, and syntactic complexity.

The term “preference regarding an amount of information” refers to a tendency of the user to favor a particular volume or density of content, such as brief summaries, medium-length explanations, or detailed descriptions.

The term “prompt sentence” refers to text data supplied as input to a generative AI model, containing instruction information that guides the model regarding subject, style, tone, structure, and other generation parameters.

The term “instruction information” refers to explicit or implicit directives included in a prompt sentence, specifying at least a content subject, detail level, writing style, dialect usage, tense usage, tone, and emotional intensity.

The term “subject of content” refers to a main topic or theme that the generated information is requested to address, as indicated in the prompt sentence.

The term “level of detail of information” refers to an intended granularity and depth of explanation in the generated information, including at least overview-level, intermediate-level, and highly detailed descriptions.

The term “writing style” refers to textual characteristics such as formality, narrative style, and rhetorical style specified for the generated information.

The term “usage of dialect” refers to an instruction regarding whether and how region-specific language variants should be reflected in the generated information.

The term “usage of tense” refers to an instruction regarding how grammatical tense forms, such as past, present, or future, should be used in the generated information.

The term “tone” refers to an overall attitude or mood conveyed by the generated information, including at least friendly, formal, enthusiastic, neutral, or comforting tones.

The term “intensity of emotional expression” refers to a magnitude of emotionally charged wording used in the generated information, indicating how strongly emotional content should be expressed.

The term “generative AI model” refers to a machine learning model configured to generate text information in response to a prompt sentence, using techniques such as deep learning and natural language processing.

The term “generated information” refers to output produced by the generative AI model, including at least text information whose content and expression style are adjusted based on input instruction information and user attributes.

The term “inference process” refers to a computational procedure executed by a trained model to transform input data into output data, without retraining the model, based on learned parameters.

The term “machine learning” refers to a computational technique in which a model is trained using data to learn patterns or mappings between inputs and outputs.

The term “natural language processing” refers to a computational technique for analyzing, understanding, or generating human language in textual form.

The term “post-processing” refers to processing applied to generated information after model inference, including at least adjusting tone, selecting terms, modifying sentence length, modifying paragraph structure, and adapting emotional expressions.

The term “structured information” refers to information organized into defined fields or sections, including at least title information, body information, and associated metadata. The term “title information” refers to text data representing a heading or title of generated content.

The term “body information” refers to text data representing a main content portion of the generated information, excluding the title.

The term “metadata” refers to auxiliary information describing attributes of the generated content, including at least emotion labels, topic labels, style indicators, timestamps, or identifiers.

The term “information display format” refers to a data representation used for displaying or transmitting generated content, including at least markup data formats, hierarchical data formats, and character-string data formats.

The term “markup data format” refers to a representation that includes structural tags or markup elements used to describe document structure and presentation.

The term “hierarchical data format” refers to a representation in which data items are nested or structured in a parent-child relationship, such as a tree-like data organization.

The term “character-string data format” refers to a representation composed primarily of plain text characters without explicit structural markup.

The term “delivery data” refers to data prepared for transmission to a terminal, including structured information encoded in a selected information display format.

The term “terminal” refers to an electronic device operated by the user, configured to receive delivery data from the server and display or otherwise output the generated content.

The term “communication network” refers to an arrangement of communication links and nodes that enables data exchange between the server and the terminal, including at least wired networks, wireless networks, or combinations thereof.

The term “usage log” refers to recorded data indicating how the user interacts with content presented on the terminal, including at least viewing time, operation history, evaluation information, and additional input information.

The term “viewing time” refers to a measure of a duration during which the user observes or remains on a particular displayed content item.

The term “operation history” refers to a sequence of user operations performed on the terminal, including at least scrolling, clicking, tapping, or selecting actions.

The term “evaluation information” refers to user-provided feedback associated with displayed content, including at least ratings, likes, reactions, or comments.

The term “additional input information” refers to user inputs other than simple viewing or navigation, including at least textual feedback, form entries, or explicit preferences.

The term “estimation result of the user attributes” refers to computed values or labels representing current or updated user attributes, derived from analysis of usage logs and stored data.

The term “estimation result of the emotional state” refers to a computed representation of the user's current emotional condition, derived from analysis of data such as document data, audio-related data, image-related data, or usage logs.

The term “weighting parameters” refers to numerical or logical parameters used to control the relative importance of different user attributes or factors when generating a prompt sentence.

The term “external emotion analysis program” refers to a software component or service located outside the server that analyzes user-related data to determine emotion classification information.

The term “internal emotion analysis program” refers to a software component implemented within the server that analyzes user-related data to determine emotion classification information.

The term “emotion classification information” refers to data indicating one or more emotion types assigned to user-related data, optionally including a probability or confidence degree for each emotion type.

The term “confidence degree” refers to a numerical indicator of reliability or likelihood that a particular emotion classification or other classification result is correct.

The term “tone instruction” refers to an element of instruction information in the prompt sentence that specifies a desired tone for the generated information.

The term “expression intensity instruction” refers to an element of instruction information in the prompt sentence that specifies a desired level of emotional intensity in the generated information.

The term “communication interface” refers to a hardware or software interface used by the processor to send or receive data over a communication network.

The term “processor” refers to one or more hardware processing units configured to execute instructions, perform computations, and control operations of the system according to program code.

In one embodiment, a server executes a content generation and delivery program that implements the claimed system. The server includes at least one processor, a main memory, a nonvolatile storage device, and a communication interface. The server is connected via a communication network to one or more terminals operated by users. Each terminal includes at least a processing unit, a display device, an input device, and a communication module.

The server uses a general-purpose computing platform such as an x86-based or ARM-based server equipped with a graphics processing unit. The server uses an operating system, a database management system, a web application framework, and a machine learning framework. For example, the server uses a relational database engine to store user data, a scripting language runtime and associated libraries (such as a numerical computation library and a data frame library) to perform data analysis, and a deep learning framework such as a tensor-based framework or an automatic differentiation framework to execute a generative AI model. The server uses a web server and an application server to provide an API over a communication protocol.

The server stores in the storage medium several software modules, including a data acquisition module, a user attribute inference module, an emotion analysis module, a prompt generation module, a generative inference module, a post-processing module, a format conversion module, and a usage-log analysis module. Each module is implemented as executable instructions that the processor reads from the storage medium and executes. The server acquires user-related data from multiple sources. The server receives HTTP or HTTPS requests from the terminal that contain at least a user identifier, session information, and interaction data. The server also periodically requests external document data from an external information source via an application programming interface. Such external document data include text posts, comments, or messages associated with the user. The server stores the acquired data into structured tables in a relational database, where each record includes at least a user identifier, a timestamp, a data type, and a payload field. This concrete data structure enables the server to perform efficient indexed retrieval and join operations when combining browsing history, profile information, preference information, and emotion-related data.

The server analyzes the stored data to infer user attributes. The server uses a user attribute inference module to read from the database the browsing history of the user, including categories and identifiers of previously consumed content, timestamps, and dwell times. The server uses a data frame library to aggregate these records, compute frequency distributions of accessed categories, and derive an interest score vector over a predefined category set. The server normalizes these scores and selects one or more dominant categories as interest fields of the user.

The server also analyzes language-related information. The server examines past feedback, past generated content responses, and profile data to determine a language expression style, such as formal or casual. The server identifies dialect usage by mapping geographic attributes (for example, residence region) to a dialect code and by analyzing linguistic features in user-generated text using a text classification model. The server determines an expression strength preference by checking which tone of past generated content produced higher engagement; for example, the server compares usage logs for content marked as “strong tone” versus “soft tone” and updates a preference parameter accordingly. The server likewise estimates a difficulty level of sentences and a preferred amount of information by evaluating correlations between article lengths, syntactic complexity indicators (such as average sentence length), and actual viewing times.

The server performs emotion analysis using an emotion analysis module. The server can use an internal emotion analysis program implemented as a neural network classifier. In one implementation, the server uses a recurrent or transformer-based neural network that receives tokenized text sequences derived from the user's document data and outputs probabilities for emotion types such as joy, sadness, anger, and neutrality. The network includes an embedding layer that maps tokens to continuous vectors, a sequence encoding layer that may be a bidirectional recurrent unit or a self-attention based transformer, and a classification head that computes a logit vector followed by a softmax operation. The server computes a cross-entropy loss during pre-training and uses a gradient-based method to update model weights. The server may also fine-tune the model on domain-specific data. The server stores the resulting emotion probabilities as emotion classification information including a confidence degree for each emotion.

Alternatively, the server uses an external emotion analysis program accessible via a network API. The server sends the user's document data, and optionally audio-related or image-related data, to this external program and receives emotion classification information and confidence degrees in response. The server then selects the most probable emotion as the current emotional state of the user, subject to a threshold on confidence degree. The server generates a prompt sentence for a generative AI model using the prompt generation module. The server retrieves the identified user attributes, such as interest fields, language expression style, dialect usage preference, expression strength, difficulty level, and information amount preference, as well as the current emotional state, from the storage medium. The server constructs an instruction vector that encodes these attributes in a structured representation. For example, the server defines a finite set of possible tones (friendly, formal, enthusiastic, comforting), a discrete set of target article lengths, and a set of flags for dialect usage and tense usage. The server then maps the instruction vector into a natural-language prompt sentence using template-based rules.

The server uses non-conventional rules to construct the prompt sentence. Instead of simply including topic keywords, the server explicitly embeds constraints on tone, dialect, tense, and emotional intensity. This rule-based assembly uses conditional clauses: for example, if the emotional state is sadness, the server adds instructions to use a comforting tone and to avoid harsh expressions; if the interest field includes law and the dialect usage preference is set to a specific regional dialect, the server adds instructions for that dialect and includes legal terminology with plain explanations.

The server can generate prompt sentences such as:
“User hometown: Kansai region.
User interests: law.
Current Emotion: Joy.

Please generate the latest legal news article in Kansai dialect. Use legal technical terms where appropriate, but keep the explanations easy to understand. Use a joyful and friendly tone, and add enthusiastic commentary about law-related topics.”

In another example, the server generates:

“The user is very interested in both technology and sports. Please generate an article about how cutting-edge technology is changing professional sports, including examples of AI-based analytics and wearable devices. Use an energetic and exciting tone, and keep the explanations clear and accessible for general readers.”

In yet another example, the server generates:

“The user feels tired and wants to relax. Please generate an article that introduces relaxing music playlists and simple breathing exercises. Use a very soft, comforting tone and short, easy-to-read sentences. Avoid negative or stressful topics.”

Because the server encodes many orthogonal constraints into the prompt sentence, the generative AI model receives a richer control signal than in conventional systems, enabling the server to control the generated output along multiple dimensions.

The server performs generative inference using a generative AI model deployed either as an internal model or as an external service. In one embodiment, the generative AI model is a transformer-based language model trained on large text corpora. The model includes an embedding layer, multiple transformer blocks each comprising multi-head self-attention sub-layers and feedforward sub-layers, and an output linear layer followed by a softmax function over a token vocabulary. The server provides the prompt sentence to the model as a sequence of tokens and configures decoding parameters such as maximum token length, temperature, and top-k or nucleus sampling thresholds.

The server executes inference on a graphics processing unit. The GPU executes matrix multiplications and attention operations using highly parallel arithmetic units, reducing latency compared to a purely central-processing-unit-based implementation. The server thereby improves processing speed for long and complex prompt sentences and reduces queuing times for multiple user requests. During inference, the model uses its learned weight matrices to compute contextualized representations and predict the next token at each step until a termination condition is met. The server collects the generated tokens and decodes them into text as generated information.

The server then performs post-processing on the generated information. The post-processing module analyzes the generated text with a natural language processing pipeline. The server segments the text into sentences using sentence boundary detection heuristics and calculates statistics such as average sentence length and vocabulary diversity. The server compares these statistics against the target difficulty level and amount-of-information preference. If the text exceeds a maximum length or uses too many complex sentences relative to the inferred user preference, the server applies rewriting rules to split long sentences or summarize some sections. The server may also re-run a sentiment analysis classifier over the generated text to verify that the overall tone matches the intended tone instruction in the prompt sentence. If discrepancies are detected, the server replaces or adjusts specific phrases using a synonym dictionary and pattern-based rewriting rules.

The server structures the post-processed generated information as structured information. The server identifies a title candidate as the first sentence or the most representative sentence using a scoring function, and stores it as title information. The server stores the remaining text as body information. The server also attaches metadata such as identifiers for user attributes, selected emotion label, generation time, and representation-format flags. The server stores this structured information in a record-oriented data structure or a document store, facilitating indexing and later retrieval.

The server converts the structured information into multiple information display formats. The format conversion module renders markup data by instantiating templates with placeholders for title, paragraphs, and metadata tags. The server generates hierarchical data, such as a tree-like representation, by organizing title and section nodes and assigning child nodes for paragraphs. The server generates character-string data by concatenating title information and body information using formatting characters. By performing these conversions on the server side, the system offloads heavy processing from terminals, which may have limited computing power.

The terminal receives delivery data from the server and presents it to the user. The terminal decodes markup data using a web rendering engine or parses hierarchical or character-string data using application logic. The terminal displays the title and body on the display device and allows the user to scroll, tap links, or perform other operations. The terminal records usage metrics such as viewing time, scroll depth, and explicit feedback actions. The terminal periodically transmits collected usage logs to the server.

The server collects usage logs and updates user attributes and emotional state estimates. The usage-log analysis module reads viewing time, operation history, evaluation information, and additional input information from the logs and aggregates them by content type and presentation style. The server uses statistical models or simple update rules to modify weighting parameters for interest fields, preferred difficulty level, and tone preferences. For example, if the user consistently reads technology-related articles to the end but abandons lengthy legal articles early, the server reduces the target length for future legal content while maintaining or increasing depth for technology content. The server also refines emotion-related parameters if patterns indicate that certain tones lead to higher engagement when the user is in a specific emotional state. These updates are stored as revised user attributes and weighting parameters in the database.

Because the server uses these updated weighting parameters in subsequent prompt sentence generation, the system implements a feedback loop that adapts prompt content over time. This loop is not a mere automation of human content editing; it exploits interactions between low-level data structures (log tables, feature vectors, and instruction vectors), specific model architectures, and server-side resource scheduling. The server reduces redundant generation of content that is unlikely to be consumed, thereby lowering computational load on the generative AI model. This reduction in load translates to fewer GPU inference cycles and reduced energy consumption. Additionally, the server's explicit multi-format conversion and caching of structured information allow reuse of the same generated core content across different terminal types without re-invoking the generative AI model, which further decreases processing latency and network usage.

In one alternative embodiment, the server uses a different generative model architecture, such as a sequence-to-sequence model with attention. The fundamental principle remains that the server encodes detailed user attributes and emotion-related constraints into the prompt sentence and uses post-processing and feedback to refine subsequent prompts. In another variation, the emotion analysis module uses multimodal inputs, such as audio prosody or image features extracted from camera frames, which are processed by convolutional or convolutional-recurrent neural networks to compute emotion classification information.

In yet another embodiment, the user attribute inference module uses an unsupervised or semi-supervised clustering algorithm to identify latent user segments. The server assigns the user to a cluster based on recent behavior and uses cluster-level parameters to initialize the prompt-generation weights. This approach improves convergence and stability of personalization when explicit data are sparse.

From a technical standpoint, the described configuration yields several effects. The server reduces average response time for content generation by precomputing and updating user attributes and by structuring model inference calls with tightly controlled prompt sentences. The server improves accuracy and relevance of generated information by tuning multiple dimensions of content generation—topic, length, tone, dialect, tense—based on both static attributes and dynamic emotional state. The server improves data management by separating raw logs, derived attributes, instruction vectors, and structured generated content into distinct data structures optimized for their respective access patterns. The server improves computational efficiency by reusing structured content across different formats and by adaptively adjusting generation length to match user behavior, thereby avoiding unnecessary token generation. The server reduces communication load by transmitting only the specific information display format that matches the requesting terminal type and by avoiding repeated large model calls when minor format adjustments suffice.

The system therefore provides more than a generic automation of human editorial tasks. The server uses specific, non-conventional rules to map multi-source user and emotion data into a prompt sentence, controls a concrete generative AI model architecture running on specialized hardware, and implements a feedback-driven adaptation process at the infrastructure level. This combination improves the functioning of the computer system itself in terms of processing speed, resource utilization, and accuracy of personalization, leading to a technical effect that is directly tied to the claimed structure and operations.

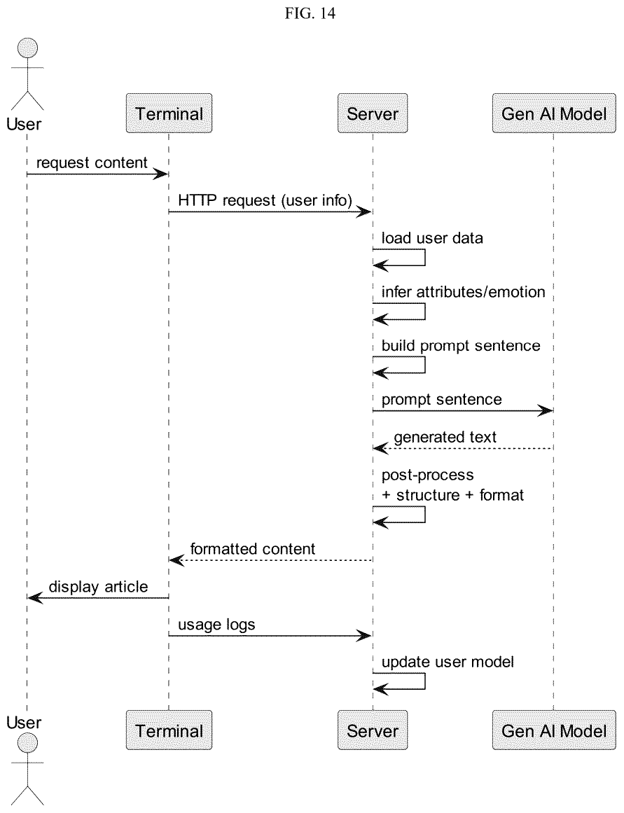

The following describes the processing flow using FIG. 14.

Step 1:

The terminal sends a content request to the server.

The terminal uses a communication module to transmit an HTTP or HTTPS request including at least a user identifier, session identifier, device type, and current screen context (for example, requested category or entry point).

Input: user ID, session data, device type, requested content type.

Output: a structured request message received by the server.

Step 2:

The server receives the request and parses basic parameters.

The server's web application framework extracts the user identifier, requested content type, and device type from the request headers and body, and converts them into internal variables.

Input: structured request message from the terminal.

Output: parsed request parameters stored in memory (user_id, content_type, device_profile).

Step 3:

The server retrieves stored user-related data from the database.

The server sends SQL queries to a relational database to obtain records for the user, including browsing history, profile information, stored preference information, and past usage logs. The server also retrieves any stored emotion history and previously computed attribute vectors.

Input: user_id and database connection.

Output: raw user data tables (browsing_history, profile, preferences, usage_logs, emotion_history) loaded into memory.

Step 4:

The server acquires external document data related to the user.

The server calls one or more external information sources via an API using stored authorization tokens and fetches recent posts, comments, or messages authored by or associated with the user. The server normalizes these documents by removing URLs, normalizing character encoding, and filtering unsupported symbols.

Input: user_id and API credentials.

Output: a list of cleaned document texts associated with the user.

Step 5:

The server infers interest fields from browsing history and usage logs.

The server uses a data frame library to aggregate the browsing_history and usage_logs by content category, computes view counts and total dwell times per category, and normalizes these metrics to produce a category score vector. The server then selects the top categories as interest fields.

Input: browsing_history records, usage_logs records.

Output: an interest vector and a ranked list of interest fields for the user.

Step 6:

The server determines preferred language expression style and dialect usage.

The server analyzes the profile information (for example, residence region and declared language) and past user-generated text from the document data to detect region-specific vocabulary or patterns using a text classifier. The server assigns a dialect flag (for example, regional dialect vs. standard language) and a formality level (for example, casual vs. formal) based on learned thresholds.

Input: profile data, external document texts.

Output: language_style parameters (formality_level, dialect_code, dialect_usage_flag).

Step 7:

The server estimates expression strength, difficulty level, and information amount preference.

The server correlates past generated content attributes (tone tags, length, sentence complexity scores) with observed engagement metrics from usage_logs (completion rate, average dwell time). Using regression or rule-based thresholds, the server estimates whether the user prefers strong or soft expressions, short or long articles, and simple or complex sentences.

Input: past content metadata, usage_logs records.

Output: style_preference parameters (expression_strength, target_length_range, difficulty_level).

Step 8:

The server analyzes the current emotional state of the user.

The server passes the cleaned document texts, and optionally recent in-app comments, to an internal or external emotion analysis program. The emotion classifier computes probabilities for emotion types such as joy, sadness, anger, and neutrality. The server selects the emotion with the highest confidence above a threshold as the current emotional state.

Input: external document texts, optional in-app text.

Output: emotion_label and confidence scores for each emotion type.

Step 9:

The server composes an instruction vector for prompt generation.

The server collects all inferred attributes: interest fields, language_style parameters, style_preference parameters, and emotion_label. The server encodes these as discrete codes and numeric values in a fixed-length instruction vector, where each dimension corresponds to a control aspect such as tone, dialect, target tokens, and tense usage.

Input: user attribute estimates and emotion_label.

Output: instruction_vector representing constraints and preferences for generation.

Step 10:

The server generates a natural-language prompt sentence from the instruction vector.

The server uses template rules and conditional logic to map each instruction element into text clauses. The server concatenates clauses about topic, dialect, tone, length, difficulty, and emotion handling into a coherent prompt sentence for the generative AI model. Input: instruction_vector.

Output: prompt sentence text ready to be supplied to the generative AI model.

Step 11:

The server sends the prompt sentence to the generative AI model and configures inference parameters.

The server creates a request payload containing the prompt sentence, a model identifier, and decoding parameters such as maximum token count, temperature, and sampling strategy. The server transmits this payload to an internal or external generative AI endpoint over a communication protocol.

Input: prompt sentence and model configuration parameters.

Output: a generative AI model inference request.

Step 12:

The server receives generated text from the generative AI model.

The server waits for a response from the generative AI model and parses the returned data structure to extract the generated token sequence and associated metadata such as token likelihoods. The server decodes the tokens into a continuous text string as initial generated content.

Input: generative AI model response.

Output: raw generated article text and optional generation metadata.

Step 13:

The server performs quality and tone validation on the generated text.

The server runs a secondary analysis pipeline that segments the text into sentences, measures sentence length and vocabulary complexity, and evaluates sentiment using a sentiment classifier. The server compares these metrics and sentiment scores with the target tone, difficulty_level, and target_length_range from the instruction_vector to detect mismatches.

Input: raw generated article text, instruction_vector.

Output: validation results and a set of detected deviations (for example, excessive length, tone mismatch).

Step 14:

The server adjusts the generated text via rule-based post-processing.

The server applies rewriting rules based on the validation results. For example, the server shortens or splits long sentences, removes or replaces overly strong expressions with softer synonyms when expression_strength is soft, and trims content if length exceeds the upper bound of target_length_range. The server also enforces tense usage instructions by detecting tense forms and rewriting inconsistent segments.

Input: raw generated article text, validation results, instruction_vector.

Output: post-processed article text that better matches user attributes and emotional state.

Step 15:

The server structures the post-processed text into title, body, and metadata.

The server selects a title by scoring candidate sentences based on position, length, and keyword density, then assigns the top-scoring sentence as title information. The server assigns the remaining text as body information and attaches metadata such as interest fields, emotion_label, generation time, and applied style parameters. Input: post-processed article text, instruction_vector.

Output: structured_content object (title, body, metadata).

Step 16:

The server converts the structured content into multiple information display formats.

The server renders markup data by inserting title and body into predefined markup templates, generates hierarchical data by constructing nested key-value structures for title, sections, and paragraphs, and produces character-string data by concatenating fields with delimiters. The server selects the appropriate format based on device_profile and caches all formats for reuse.

Input: structured_content, device_profile.

Output: formatted_content variants in markup, hierarchical, and character-string formats.

Step 17:

The server transmits a selected formatted content to the terminal.

The server builds an HTTP or HTTPS response whose body contains the formatted_content variant chosen for the terminal's device type, and sets corresponding headers such as content-type and cache-control. The server then sends the response via the communication network to the terminal.

Input: formatted_content variants, device_profile.

Output: a content response delivered to the terminal.

Step 18:

The terminal receives the content response and displays the article. The terminal parses the received data according to its format (for example, uses a browser engine for markup data or application logic for hierarchical data) and renders the title and body on the display. The terminal prepares interactive elements, such as scrollable views and buttons for feedback.

Input: content response from the server.

Output: visual presentation of the article on the terminal display.

Step 19:

The user reads and interacts with the displayed article.

The user scrolls through the article, selects links, changes sections, or inputs explicit feedback such as likes or ratings using the input device of the terminal.

Input: article display and user intentions.

Output: interaction events on the terminal (scrolls, taps, typed feedback).

Step 20:

The terminal records interaction events as usage logs.

The terminal monitors scrolling position, viewing duration, clicks, and feedback actions, and timestamps each event. The terminal aggregates these events into a usage log data structure containing article identifier, user identifier, event types, and metrics such as total view time and scroll depth.

Input: interaction events generated by the user.

Output: locally stored usage log records.

Step 21:

The terminal transmits usage logs to the server.

The terminal sends the usage log records to the server at configured intervals or upon session end, bundling multiple events into a compact payload to reduce communication overhead. The terminal uses an authenticated HTTP or HTTPS request to transmit this payload.

Input: usage log records.

Output: a usage log upload request received by the server.

Step 22:

The server receives and stores the usage logs.

The server parses the uploaded payload, validates the schema, and inserts the log entries into one or more database tables or log storage indices with proper indexing on user_id and article_id.

Input: usage log upload request.

Output: persisted usage_log entries ready for analysis.

Step 23:

The server updates user attributes and weighting parameters using the new logs.

The server's usage-log analysis module reads the newly stored usage logs, aggregates them by content attributes (topic, length, tone), and calculates updated engagement metrics such as completion rate and mean viewing time per attribute configuration. Based on these metrics, the server adjusts weighting parameters in the user model that influence interest fields, target_length_range, difficulty_level, and preferred tone.

Input: new usage_log entries, existing user model parameters.

Output: updated user attribute estimates and weighting parameters stored in the database.

Step 24:

The server incorporates updated parameters into future prompt sentence generation.

The server uses the updated user attributes and weighting parameters when it next invokes the instruction-vector generation and prompt generation modules, causing subsequent prompt sentences to encode refined constraints and preferences. This adaptive process gradually improves alignment between generated content and user behavior.

Input: updated user attribute estimates and weighting parameters.

Output: refined instruction_vector and future prompt sentences that reflect the latest user behavior and emotional patterns.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

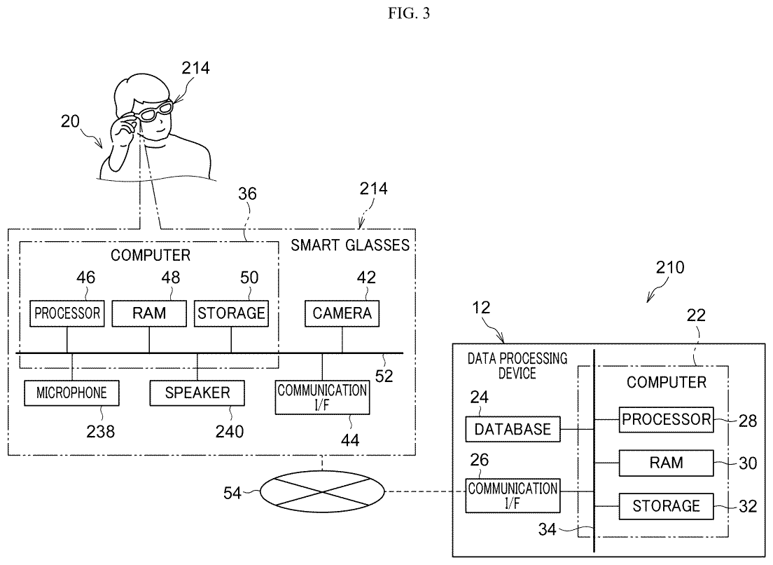

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

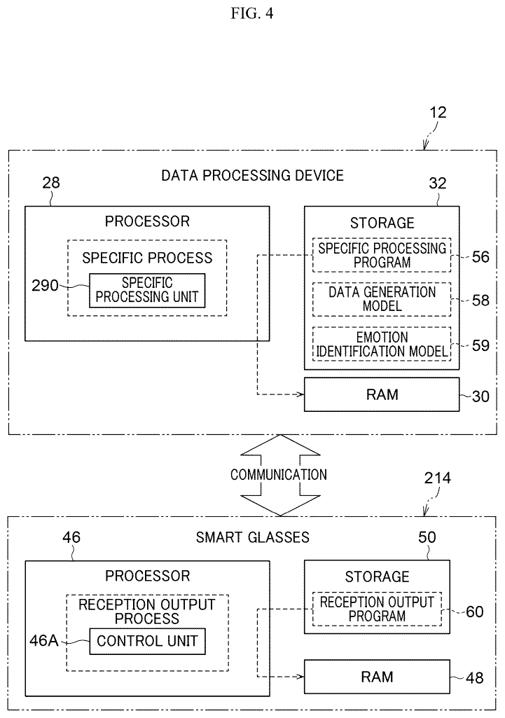

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

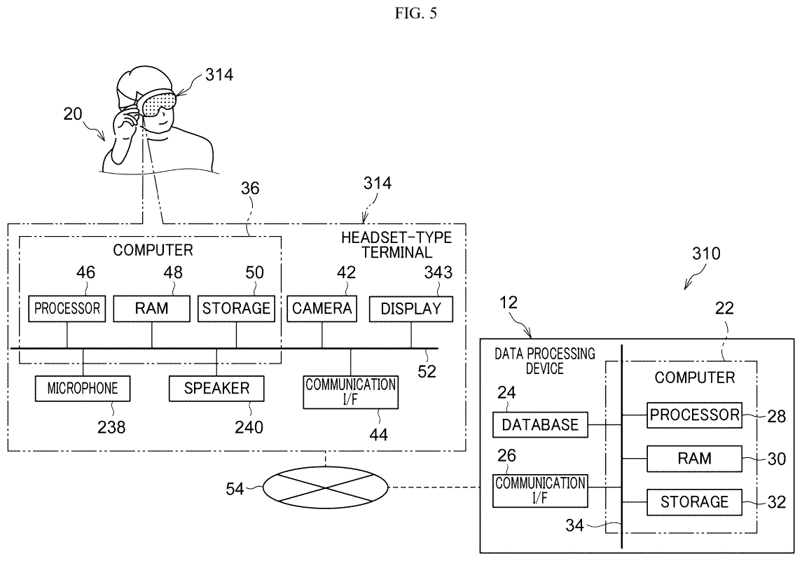

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

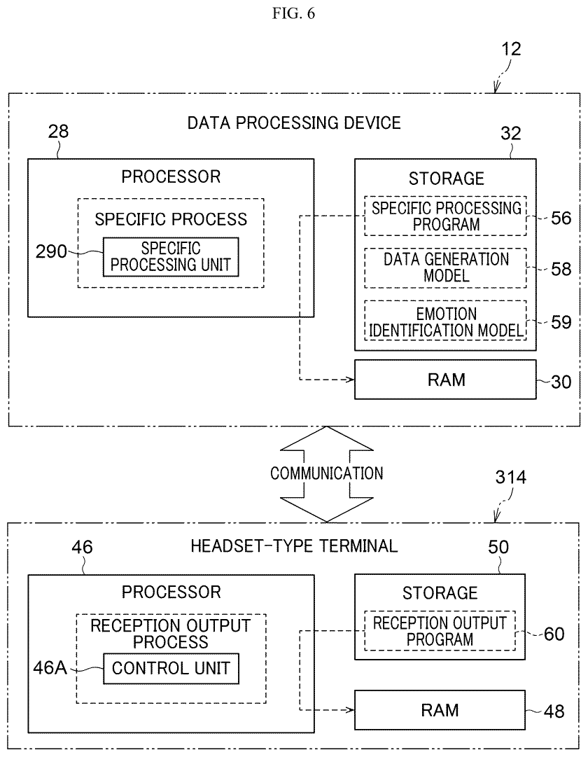

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

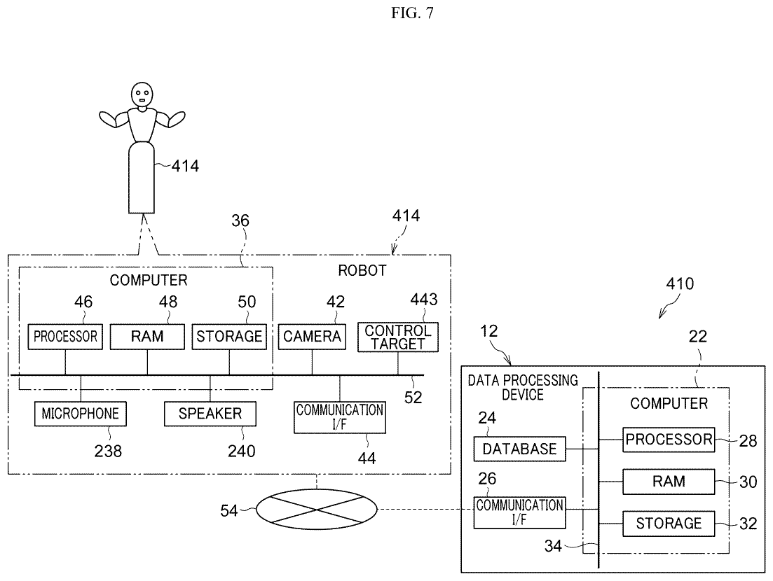

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

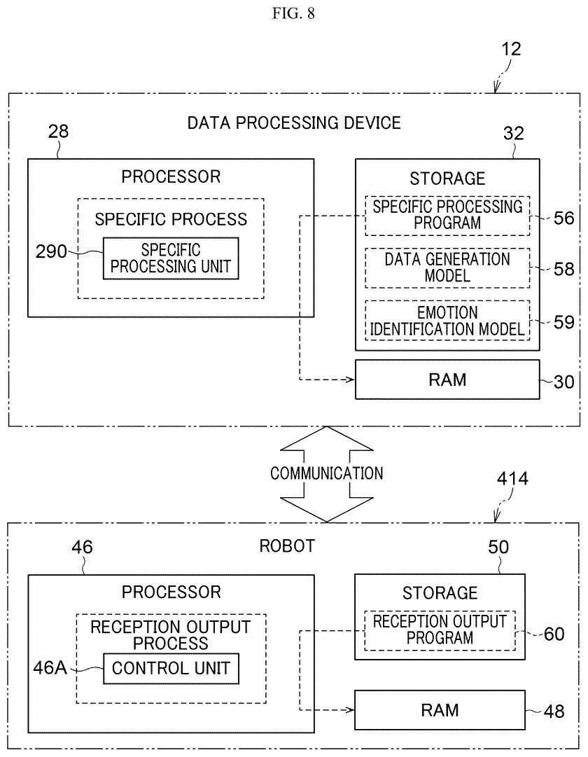

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

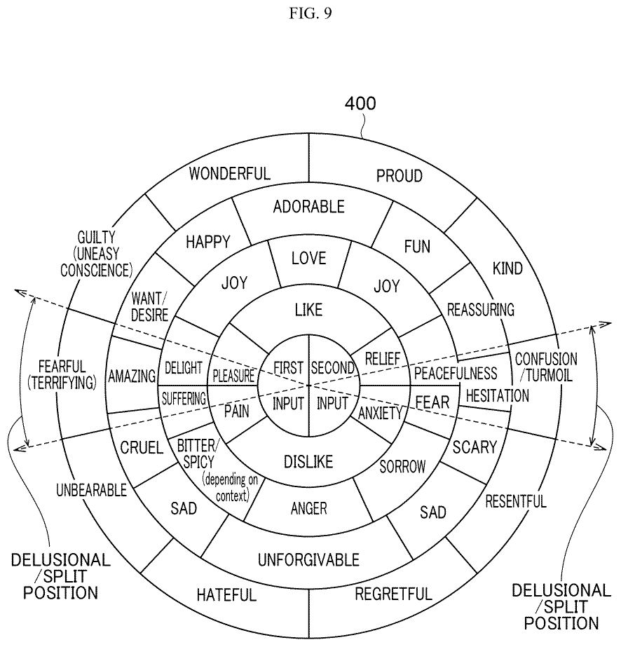

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

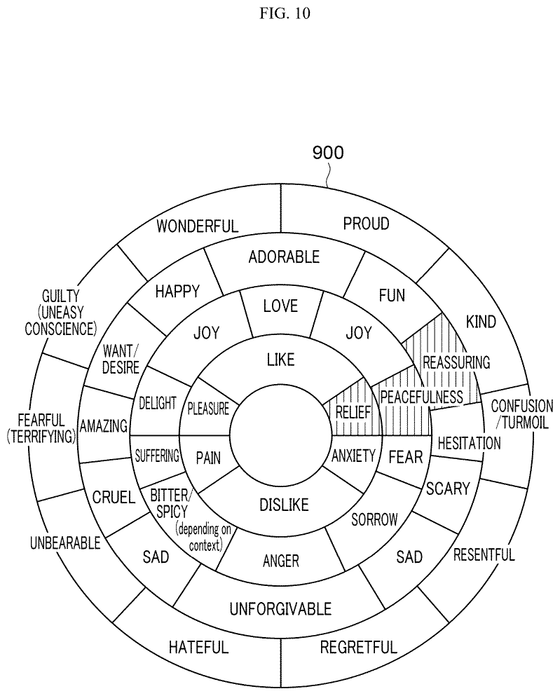

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

Example 1

### Supplementary 1

A system comprising a processor,
wherein the processor is configured to
acquire and store behavior-related information including viewing history information, attribute information, preference information, and emotion information of a user, and
execute information analysis processing including machine learning processing and natural language processing on the behavior-related information to extract user characteristic information including a field of interest of the user, a preferred amount of information, a preferred writing style, a preferred use of region-specific language, a preferred degree of emphasis, and a preferred tense, and
generate a prompt sentence in which constraint conditions including a target field of generated information, an amount of the generated information, a language style, region-specific expressions, soft expressions or emphasized expressions, conciseness, and a tense specification for past information are explicitly described, based on the user characteristic information, and
configure the generated prompt sentence as input data to be input to a generative AI model and acquire natural language text output from the generative AI model so as to be compatible with the user characteristic information, and
execute post-processing including at least one of writing-style conversion processing, region-specific expression adding processing, and tense adjustment processing on the natural language text acquired from the generative AI model to generate information content to be presented to the user, and
transmit the generated information content to a terminal device of the user and control output so that the information content becomes displayable on the terminal device.

### Supplementary 2

The system according to supplementary 1,
wherein the processor is configured to
acquire evaluation information and operation history information from the user in the information analysis processing, and update the user characteristic information and generation conditions of the prompt sentence by using reinforcement learning processing, thereby adapting a subsequently generated prompt sentence and subsequently generated information content to preferences of the user.

### Supplementary 3

The system according to supplementary 1,
wherein the processor is configured to
hold template information for each field of interest of the user when generating the prompt sentence to be input to the generative AI model, and dynamically generate the prompt sentence including different constraint conditions and output formats for each generation target field by selecting or combining the template information based on the user characteristic information.

### Application Example 1

### Supplementary 1

A system comprising a processor,
wherein the processor is configured to acquire, based on user identification information, usage history information and attribute information from an information storage device, and to extract and normalize user attributes including at least a field of interest of a user, a preference for an expression style, a preference for a language style, and a preference for a level of comprehension difficulty,
wherein the processor is configured to construct, in a natural language, a prompt sentence that explicitly specifies the field of interest of the user, a tone, a dialect, a level of sentence complexity, a tense, and an emotional intensity of expressions, on the basis of the normalized user attributes and generation conditions indicating an information field to be provided, an amount of information, and a time range,
wherein the processor is configured to input the prompt sentence and the user attributes into a generative AI model that uses deep learning and natural language processing, and to cause the generative AI model to generate personalized information in which content and expression style are adjusted according to the user attributes,
wherein the processor is configured to perform post-processing on the generated personalized information with respect to at least the expression style, safety, and length, and to format the generated personalized information into a display format for a display device, wherein the processor is configured to transmit the formatted personalized information to an information terminal via a communication path and to provide the formatted personalized information in a format displayable on the information terminal, and
wherein the processor is configured to collect viewing operation information and reaction information transmitted from the information terminal, and to update the user attributes based on the collected information so as to dynamically change, for subsequent generation, the prompt sentence and the personalized information.

### Supplementary 2

The system according to supplementary 1,
wherein the processor is configured to include, as separate descriptive elements in construction of the prompt sentence, a primary field of interest, a secondary field of interest, a preferred tone type, a preferred regional language style, and a preferred level of comprehension difficulty estimated from the user attributes, and thereby to enable simultaneous control of the respective descriptive elements at a time of information generation by the generative AI model.

### Supplementary 3

The system according to supplementary 1,
wherein the processor is configured to acquire, as the viewing operation information and the reaction information, at least a movement amount of a display area, a dwell time, a selection operation, a save operation, and a share operation, and to recalculate weighting of at least the field of interest, the preference for the expression style, and the preference for the level of comprehension difficulty based on acquisition results of the viewing operation information and the reaction information, thereby updating the user attributes.

### Example 2

### Supplementary 1

A system comprising a processor,
wherein the processor is configured to
read, from a storage device based on user identification information received via a communication network, behavioral history information and attribute information of a user, and analyze the behavioral history information and the attribute information to extract user attributes including at least a region of the user, a language style, a necessity of dialect use, a preferred field, a strength of expression, a sentence complexity, and a tense preference,
determine internal parameters that define conditions relating to a subject of information content, an amount of information, a used language, a used dialect, a writing style, a strength of expression, and a tense, in accordance with the extracted user attributes, and generate a prompt sentence to be input to a generative AI model, based on the internal parameters and template information stored in advance,
transmit the generated prompt sentence to an information generation apparatus including the generative AI model via a communication interface, and acquire information content generated by the generative AI model in accordance with the user attributes,
apply, to the acquired information content, post-processing rules or a rewriting process using the generative AI model so as to reflect user preferences relating to strength of expression, politeness, tolerance of technical terms, and sentence length, and thereby generate customized information in which vocabulary, sentence-ending expressions, sentence length, and tense of the information content are adjusted, and
transmit the customized information to a user terminal, update the behavioral history information based on viewing operation information for the customized information received from the user terminal, and, based on the updated behavioral history information, relearn the user attributes so as to automatically optimize, for subsequent processing, the prompt sentence and the customized information to be generated.

### Supplementary 2

The system according to supplementary 1,
wherein the processor is configured to
generate, when generating the customized information, an additional prompt sentence for the generative AI model that includes the acquired information content as input text, acquire rewrite information for rewriting the information content into a predetermined language style or dialect based on the additional prompt sentence, and transmit the rewrite information, as the customized information, to the user terminal.

### Supplementary 3

The system according to supplementary 1,
wherein the processor is configured to
calculate, based on the viewing operation information including at least one of viewing completion time, scrolling operation, selection operation, and evaluation operation transmitted from the user terminal, weighting parameters for each user relating to at least one of topic field, language style, dialect, strength of expression, and amount of information, and reflect the weighting parameters, as the user attributes, in generation of the prompt sentence and generation of the customized information.

### Application Example 2

### Supplementary 1

A system comprising a processor,
wherein the processor is configured to
acquire, via a communication interface, data including browsing history of a user, attribute information of the user, preference information of the user, document data obtained from an external information source, and information indicating an emotional state of the user, and store the acquired data in a storage medium,
analyze the stored data and identify user attributes including at least an interest field of the user, a language expression style of the user, presence or absence of dialect usage, strength or softness of expressions, difficulty level of sentences, preference regarding an amount of information, and a current emotional state of the user,
generate text data forming a prompt sentence to be input to a generative AI model, the prompt sentence including instruction information that specifies at least a subject of content, a level of detail of information, a writing style, usage of dialect, usage of tense, a tone, and an intensity of emotional expression, based on the identified user attributes and the current emotional state,
input the generated prompt sentence to the generative AI model and obtain generated information including text information whose content and expression style are adjusted in accordance with the user attributes and the current emotional state, by an inference process using machine learning and natural language processing,
perform post-processing on the obtained generated information such that at least a tone of expression, a selection of terms, a length of sentences, a paragraph structure, and emotional expressions are made compatible with the user attributes and the current emotional state, and format the post-processed generated information as structured information including title information, body information, and associated metadata,
convert the structured information into a plurality of information display formats including at least a markup data format, a hierarchical data format, and a character-string data format, and generate delivery data that is transmittable in an information display format selected in accordance with a type of a terminal used by the user,
transmit the delivery data to the terminal of the user via a communication network, and
acquire, from the terminal of the user, a usage log including at least viewing time, operation history, evaluation information, and additional input information relating to a display based on the delivery data, and update an estimation result of the user attributes and the emotional state based on the usage log.

### Supplementary 2

The system according to supplementary 1,
wherein the processor is configured to
analyze the usage log and update weighting parameters relating to at least the interest field of the user, preference regarding an amount of sentences, difficulty level of expressions, and preferred tone, and reflect the updated weighting parameters in a subsequent generation process of the prompt sentence so as to adaptively change input content to the generative AI model over time.

### Supplementary 3

The system according to supplementary 1,
wherein the processor is configured to
analyze at least one of document data, audio-related data, and image-related data of the user by using an external emotion analysis program or an internal emotion analysis program, compute emotion classification information including a plurality of emotion types and a confidence degree for each of the emotion types, and determine, based on the emotion classification information and the confidence degree, at least a tone instruction and an expression intensity instruction in the prompt sentence.

What is claimed is:

1. A system comprising:
circuitry configured to:
acquire, via a communication interface coupled to a packet-switched network, behavior log data of a user from a terminal device and from one or more external information sources, the behavior log data comprising interaction history records, attribute data, preference indicator data, and affective state data;
execute an analysis operation on the behavior log data using a machine learning model and a natural language processing pipeline to extract user characteristic data comprising a topic interest distribution, a preferred information quantity parameter, a style profile comprising writing style indicators, region-specific expression indicators, emphasis level indicators, and tense preference indicators;
construct a constrained instruction sequence based on the user characteristic data, the constrained instruction sequence comprising constraint condition parameters explicitly specifying a target topic field, an output length range, a language style directive, a region-specific expression directive, an emphasis level directive, and a tense specification directive;
input the constrained instruction sequence into a generative neural network model comprising a transformer-based architecture and acquire generated text data from the generative neural network model;
execute a post-processing operation on the generated text data, the post-processing operation comprising at least one of a style conversion operation, a region-specific expression insertion operation, and a tense adjustment operation, to produce output content data conforming to the style profile; and
transmit the output content data to the terminal device via the communication interface.

2. The system according to claim 1, wherein the circuitry is further configured to:
compute the topic interest distribution by applying a topic modeling operation to the interaction history records to generate topic probability vectors, and derive the style profile by analyzing linguistic features of prior user-generated text data using the natural language processing pipeline to identify patterns in sentence length, vocabulary level, formality, and regional expression usage.

3. The system according to claim 2, wherein the circuitry is further configured to:
select a prompt template from a plurality of prompt templates stored in an information storage device based on the topic interest distribution, and populate the selected prompt template with the constraint condition parameters derived from the user characteristic data to generate the constrained instruction sequence.

4. The system according to claim 3, wherein the constraint condition parameters further comprise:
a tense control parameter specifying whether the generated text data is to be expressed in past tense, present tense, or future tense, and an emphasis control parameter specifying whether the generated text data is to use soft expressions or emphasized expressions, the tense control parameter and the emphasis control parameter derived from the tense preference indicators and the emphasis level indicators in the style profile.

5. The system according to claim 1, wherein the post-processing operation comprises:
the style conversion operation configured to transform vocabulary and sentence structure of the generated text data to match the writing style indicators in the style profile, the region-specific expression insertion operation configured to replace generic expressions with region-specific equivalent expressions based on the region-specific expression indicators, and the tense adjustment operation configured to convert verb forms in the generated text data to conform to the tense specification directive.

6. The system according to claim 1, wherein the circuitry is further configured to:
acquire evaluation data and interaction event data from the terminal device, compute a reward signal based on the evaluation data and engagement metrics derived from the interaction event data, and update the user characteristic data and generation condition parameters for the constrained instruction sequence using a reinforcement learning operation that adjusts weighting values of the constraint condition parameters based on the reward signal.

7. The system according to claim 6, wherein the circuitry is further configured to:
compare the output content data with the constraint condition parameters to compute a conformance score, and when the conformance score is below a threshold value, modify the constrained instruction sequence by adjusting at least one of the output length range, the emphasis level directive, and the tense specification directive, and re-input the modified constrained instruction sequence into the generative neural network model to obtain refined generated text data.

8. The system according to claim 1, wherein the circuitry is further configured to:
generate a plurality of constrained instruction sequences corresponding to a plurality of topic fields identified in the topic interest distribution, input each constrained instruction sequence into the generative neural network model to generate topic-specific text data for each topic field, and aggregate the topic-specific text data into a composite output content data structure for transmission to the terminal device.

9. The system according to claim 1, wherein the generative neural network model comprises:
an embedding layer configured to convert input tokens into multidimensional tensor representations, a positional encoding module, a plurality of transformer layers each comprising multi-head self-attention and feed-forward sublayers with layer normalization, and a decoding stage configured to generate a probability distribution over a vocabulary and select output tokens using a sampling strategy with configurable temperature and top-k parameters.

10. The system according to claim 1, wherein the circuitry is further configured to:
classify the affective state data into an affective state category using a neural network classifier, and include the affective state category as an additional constraint condition parameter in the constrained instruction sequence to condition the generative neural network model to generate text data with a tone corresponding to the affective state category.

11. The system according to claim 1, wherein the circuitry is further configured to:
apply a quality validation operation to the generated text data by computing a relevance score based on semantic similarity between the generated text data and the topic interest distribution, and a style conformance score based on comparison of linguistic features of the generated text data against the style profile, and discard generated text data having a relevance score or style conformance score below respective threshold values.

12. The system according to claim 1, wherein the circuitry is further configured to:
determine a delivery timing based on temporal patterns in the interaction history records indicating time periods of high user engagement, and schedule transmission of the output content data to the terminal device to coincide with the determined delivery timing.

13. The system according to claim 6, wherein the circuitry is further configured to:
generate a plurality of variant constrained instruction sequences differing in at least one constraint condition parameter, input each variant into the generative neural network model to produce variant output content data, transmit different variants to the terminal device across successive sessions, and compute comparative engagement metrics for each variant to update the constraint condition parameters via the reinforcement learning operation.

14. The system according to claim 1, wherein the circuitry is further configured to:
acquire contextual data from one or more external information processing apparatuses via the communication interface, the contextual data comprising at least one of trending topic data, temporal event data, and geographic relevance data, and incorporate the contextual data into the constrained instruction sequence as supplemental constraint condition parameters.

15. The system according to claim 1, wherein the circuitry is further configured to:
assign the user to a user segment based on clustering the user characteristic data with characteristic data of other users using an unsupervised learning operation, and apply segment-level constraint condition parameters derived from aggregated characteristics of the user segment as default values in the constrained instruction sequence when individual user characteristic data is insufficient.

16. The system according to claim 1, wherein the circuitry is further configured to:
generate supplemental visual content data by inputting a visual generation instruction derived from the output content data into an image generation neural network, and transmit the supplemental visual content data together with the output content data to the terminal device for combined presentation.

17. The system according to claim 1, wherein the output content data comprises personalized news articles, recommendation summaries, or notification messages adapted to the user, the behavior log data comprises web browsing history and content viewing records, and the style profile governs tone, formality, and regional dialect of the output content data for a personalized information delivery service.

18. A system comprising:
circuitry configured to:
acquire behavior log data of a user from a terminal device via a communication interface coupled to a packet-switched network;
execute an analysis operation on the behavior log data to extract user characteristic data comprising a topic interest distribution and a style profile;
construct a constrained instruction sequence comprising constraint condition parameters derived from the user characteristic data and input the constrained instruction sequence into a generative neural network model to generate text data;
execute a post-processing operation on the generated text data comprising at least one of a style conversion operation, a region-specific expression insertion operation, and a tense adjustment operation to produce output content data; and
transmit the output content data to the terminal device.

19. The system according to claim 18, wherein the circuitry is further configured to:
acquire evaluation data from the terminal device and update the user characteristic data and generation condition parameters using a reinforcement learning operation based on the evaluation data.

20. A method comprising:
acquiring, by circuitry via a communication interface coupled to a packet-switched network, behavior log data of a user from a terminal device and from one or more external information sources, the behavior log data comprising interaction history records, attribute data, preference indicator data, and affective state data;
executing an analysis operation on the behavior log data using a machine learning model and a natural language processing pipeline to extract user characteristic data comprising a topic interest distribution, a preferred information quantity parameter, a style profile comprising writing style indicators, region-specific expression indicators, emphasis level indicators, and tense preference indicators;
constructing a constrained instruction sequence based on the user characteristic data, the constrained instruction sequence comprising constraint condition parameters explicitly specifying a target topic field, an output length range, a language style directive, a region-specific expression directive, an emphasis level directive, and a tense specification directive;
inputting the constrained instruction sequence into a generative neural network model comprising a transformer-based architecture and acquiring generated text data from the generative neural network model;
executing a post-processing operation on the generated text data, the post-processing operation comprising at least one of a style conversion operation, a region-specific expression insertion operation, and a tense adjustment operation, to produce output content data conforming to the style profile; and
transmitting the output content data to the terminal device via the communication interface.
